(19) United States
(12) Patent Application Publication
(10) Pub. No.: US 2022/0114616 A1
(43) Pub. Date: Apr. 14, 2022

(54) DIGITAL ANTHROPOLOGY AND ETHNOGRAPHY SYSTEM

(71) Applicant: SPLASHLIGHT HOLDING LLC, New York, NY (US)

(72) Inventors: James A. INGRAM, New York, NY (US); Benoit LAGARDE, New York, NY (US); Peter GUNTHER, New York, NY (US); Jason KEEBER, New York, NY (US); Thomas WALSHAM, Hamilton (CA); James VARGA, Toronto (CA); Josh ZUCKER, Toronto (CA); Richard C. Dodson, Cornwall (GB); Theodore Pomeroy Washburne, Harrison, NY (US)

(73) Assignee: SPLASHLIGHT HOLDING LLC, New York, NY (US)

(21) Appl. No.: 17/514,409

(22) Filed: Oct. 29, 2021

Related U.S. Application Data
(63) Continuation of application No. PCT/US2020/030999, filed on May 1, 2020.
(60) Provisional application No. 62/842,263, filed on May 2, 2019.

(51) Int. Cl. G06Q 30/02

(52) U.S. Cl. CPC G06Q 30/0251; G06Q 30/0276; G06Q 30/0205

(57) ABSTRACT

In embodiments, a digital anthropology and ethnography system is disclosed. In embodiments, the digital anthropology and ethnography system automates marketing-related tasks, such as customer segmentation, topic modeling, and media planning. In embodiments, the digital anthropology and ethnography system is configured to perform analytics related to a set of media assets, including images captured by a self-contained photography studio system.

### CROSS-REFERENCE TO RELATED APPLICATIONS

This application is a continuation of PCT International Application No. PCT/US2020/030999, filed May 1, 2020, which claims priority to U.S. Provisional Patent Application Ser. No. 62/842,263, filed May 2, 2019, entitled “TECHNOLOGIES FOR ENABLING A CONSUMER DATA PLATFORM FOR PROVIDING CREATIVE INTELLIGENCE.” The disclosures of the above applications are incorporated herein by reference in their entirety.

### FIELD

This disclosure relates to the field of digital anthropology, and more particularly to a platform with a set of machine learning, analytics, content creation, and content tracking capabilities that provide insight into personas that can be used to improve media asset creation and delivery to individuals and groups that express the digital personas. This disclosure also relates to technical applications of digital anthropology, such as media asset creation, dynamic segmentation, media planning, and the like.

### BACKGROUND

In the present day, campaigns and other communication efforts, such as marketing and/or advertising techniques, typically center around trying to capture comprehensive information about each individual consumer. This has seemed possible because so many consumers lead extensive digital lives, generating rich data with every digital action. Personalization systems seek to leverage this data to target the right individual with the right content at the right moment. However, such personalization often relies on obtaining intimate, personal data, and consumers increasingly feel invaded and abused. Governments are turning against the online advertising giants and analytics companies and are moving to enact laws that protect personal data and prohibit or restrict collection and use of such data; therefore, the power behind hyper-personalization is diminishing, creating an insight vacuum. Absent insight into an individual's interests or preferences, messages and media asset may tend to be less relevant or poorly targeted. Advertisers and others tend to broadly blanket large populations with repetitive messages, hoping that some small fraction hits the target audience. This results in a different kind of invasion, as advertising noise interferes with the ability of individuals to enjoy digital content and environments. Accordingly, there exists a need in the art for a system for providing well targeted content without invading personal data or creating invasive noise.

In addition, hyper-personalization technology tends to view each individual as exhibiting the same characteristics or behaviors over time, but individuals and groups inhabit different personas at different times—one at work, another with family, and many others as they move among various groups and everyday activities. Modern campaign systems typically miss how human personas change over time. Thus, there exists a need in the art for creating a more accurate picture of individuals and groups at the level of the persona, including an understanding of emotional and behavioral attributes of personas, such as to provide persona-based content creation, messaging, targeting, and/or advertising, among other uses.

### SUMMARY

The present disclosure relates to a platform and system, consisting of various components, modules, services, interfaces, software, workflows, and other components, that is configurable to enable development of understanding and insight into the behavior of personas, including personas embodied or expressed by individuals and groups of individuals in their interactions and relationships with digital media and within digital environments. The platform, referred to in some cases as the system, may include, among many other items, a set of machine learning algorithms that operate on a heterogeneous set of data sources, a set of systems that enable embedding of attribute information into digital media asset, and a set of systems that enable tracking and observation of reactions of personas to particular attributes or combinations of attributes of the media asset, Understanding and insight may be used for a variety of novel uses and applications in various domains, including marketing, advertising, fundraising, security, politics, and others. In embodiments, the system is customizable to perform, inter alia, cross-channel media creation and planning based on analytics and machine-learned models that in some cases may be generated at least in part using data integrated from multiple independent data sources and in some cases, may be based on tracking data relating to digital media asset genomes of media assets.

According to some embodiments of the present disclosure, methods and systems are provided herein for providing creative intelligence to users seeking to connect to and reach an audience (an individual, an entity, a specific segment of consumers, a segment of consumers belonging to a specific digital village, a segment of consumers associated with a specific digital persona, or the like) with content, such as advertising content, fundraising content, political content, advocacy content, or other content. In embodiments, the provision of creative intelligence may include making use of a wide range of data sources, such as on-line user interactions with media assets (including event tracking information, such as mouse clicks), consumer demographic and/or segmentation information, other consumer information, digital persona information, digital village information, attributes and/or metadata associated with an on-line user, media asset attribute data, survey data, point of interest information (such as data provided by Safegraph™) weather data, traffic data, police data, financial data, health data, wearable device data, social network data, thick data gathered through ethnography methods, and the like. Such information may then be utilized in a digital anthropology system, such as to provide marketing-related intelligence to users (e.g., marketers, consultants, political advisors, advocates for causes, security professionals, data scientists, digital anthropologists, advertisers, and the like) in various ways, such as for providing recommendations to users (such as suggested advertising content or advertising presentation attributes), content generation, media planning, media pricing, digital anthropology services, analytics, data visualizations, and the like.

A more complete understanding of the disclosure will be appreciated from the description and accompanying drawings and the claims, which follow.

In embodiments, a method is disclosed. The method includes receiving, by a processing system, a media asset; classifying, by the processing system, one or more elements of the media asset using a media asset classifier; attributing, by the processing system, the classifications to the media asset as media asset attributes; and generating, by the processing system, a media asset genome for the media asset based on the media asset attributes. The method further includes associating, by the processing system, the media asset genome with the media asset, and embedding, by the processing system, one or more tags and/or code into the media asset that causes a client application presenting the media asset to report tracking information relating to presentation of the media asset. The method also includes propagating, by the processing system, the media asset into at least one digital environment; receiving, by the processing system, tracking information from one or more external devices that presented the media asset to respective on-line users, each instance of tracking information indicating a respective outcome of a respective on-line user with respect to the media asset; and receiving, by the processing system, user data of the respective on-line users that were presented the media asset. The method also includes training, by the processing system, a digital anthropology system that performs tasks based, at least in part, on the media asset genome and the tracking data and user data relating to media asset genome.

In embodiments, the training of the digital anthropology system is further based on integrated data that is integrated from two or more other independent data sources. In some embodiments, the integrated data is generated by multi-basing data from two or more independent data sources. In some of these embodiments, the method further includes multi-basing the media asset genome, the tracking data, and the user data with the two or more other independent data sources. In some of these embodiments, the multi-basing is performed on-demand, such that the integrated data resulting from the multi-basing is not persistently stored. In some embodiments, the integrated data is integrated using data fusion techniques. In some embodiments, the integrated data is integrated using data ascription techniques.

According to some embodiments of the present disclosure, an image capture device is disclosed. The image capture device includes one or more lenses; a storage device; and one or more processors that execute executable instructions. The instructions cause the one or more processors to: capture an image via the one or more lenses; classify one or more elements of the media asset using an image classifier; attribute the classifications of the one or more elements to the media asset as media asset attributes; generate a media asset genome for the media asset based on the media asset attributes; associate the media asset genome with the media asset; and transmit the media asset genome and the media asset to an external device. In embodiments, the image capture device is a digital camera. In embodiments, the image capture device is a pair of smart glasses. In embodiments, the image capture device is a self-contained photography studio system. In embodiments, the external device is a creative intelligence server. In embodiments, the executable instructions further cause one or more processors to extract one or more features of the image. In some of these embodiments, extracting the one or more features includes calculating a ratio of two different elements of a subject in the image. Additionally or alternatively, extracting the one or more features includes calculating the sizes of a subject in the image in relation to other objects in the image. In some embodiments, the executable instructions further cause the one or more processors to embed one or more tags and/or code into the media asset that causes a client application presenting the media asset to report tracking information relating to presentation of the media asset.

According to some embodiments of the present disclosure, a method is disclosed. The method may include receiving, by one or more processors, a use case relating to a marketing-related task to be performed on behalf of a customer. The method further includes providing, by the one or more processors, a client algorithm to a set of hosts via a communication network, wherein the client algorithm includes a set of machine executable instructions that define a machine learning algorithm that trains a local model on a respective local data set stored by the host and provides respective results of the training to a master algorithm that is executed by the one or more processors, wherein at least one of the hosts stores a sensitive data set that is not under control of the customer. The method also includes receiving, by the one or more processors, the respective results from each of the set of hosts and updating, by the one or more processors, a global model based on the results received from the set of hosts. The method also includes receiving, by the one or more processors, a request to perform a marketing-related task on behalf of the customer and leveraging, by the one or more processors, the global model to perform the marketing-related task.

In embodiments, the respective results that are received from each of the set of hosts include a respective set of model parameters resulting from training the respective version of the local model. In some embodiments, updating the global model includes integrating the respective set of model parameters received from each of the hosts into the global model. In some embodiments, the method further includes providing, by the one or more processors, respective meta-learning information to each of the hosts in response to integrating the respective set of parameters.

In embodiments, providing the candidate algorithm to the set of hosts includes providing a starter model to each of the hosts, wherein each respective host of the set of hosts trains the respective local model from the starter model. In some embodiments, the starter model is initially trained on a representative data set. In embodiments, providing the candidate algorithm to the set of hosts includes providing the set of representative data to the set of hosts, wherein each respective host of the set of hosts validates the respective local model using the representative data set.

In embodiments, the marketing-related task is customer segmentation. In embodiments, the marketing-related task is topic modeling. In embodiments, the marketing-related task is market planning.

In embodiments, the set of hosts includes a computing environment of a commercial partner of the customer. In embodiments, the commercial environment of the customer stores sales data of the commercial partner. In embodiments, the commercial environment of the customer stores sales data of the commercial partner. In embodiments, claim 22, wherein the set of hosts include a computing environment that includes multi-based data from two independent data sources. In embodiments, the set of hosts include a computing environment that stores media asset analytics data.

### BRIEF DESCRIPTION OF THE DRAWINGS

The accompanying drawings, which are included to provide a better understanding of the disclosure, illustrate embodiment(s) of the disclosure and together with the description serve to explain the principle of the disclosure. In the drawings:

FIG. 1 is an example architecture of the digital anthropology and creative intelligence system according to some embodiments of the present disclosure.

FIG. 2A illustrates an example set of components of the digital anthropology and creative intelligence system in relation to the data source that feed into the creative intelligence system according to some embodiments of the present disclosure.

FIG. 2B illustrates an example set of components of the digital anthropology and creative intelligence system according to some embodiments of the present disclosure.

FIG. 3 illustrates a set of example components of the media processing and analytics system according to some embodiments of the present disclosure.

FIG. 4 is an example set of operations of a method for determining analytics data for a set of images, according to some embodiments of the present disclosure.

FIG. 5 illustrates an example of an algorithm selection architecture that may be implemented by the digital anthropology services system according to some embodiments of the present disclosure.

FIG. 6 illustrates an example set of components of the intelligence system according to some embodiments of the present disclosure.

FIG. 7 illustrates an example self-contained photography system according to some embodiments of the present disclosure.

### DETAILED DESCRIPTION

The present disclosure relates to a digital anthropology and creative intelligence system, referred to herein in some cases simply as the creative intelligence system 100, or as the platform or the system, that is configured to perform tasks relating to media asset classification and automated media planning (amongst other media-related AI tasks) based on analytics and machine-learned models that in some cases may be generated at least in part using data integrated from multiple independent data sources and, in some cases, may be based on tracking data relating to digital genomes of media assets. In embodiments, the digital anthropology and creative intelligence system 100 aggregates a wide variety of data and provides users such as brand representatives or marketers with creative intelligence or digital anthropology services around personality, behavior, and emotions of personas, such as to support users in creating and implementing media campaigns or other media-related activities.

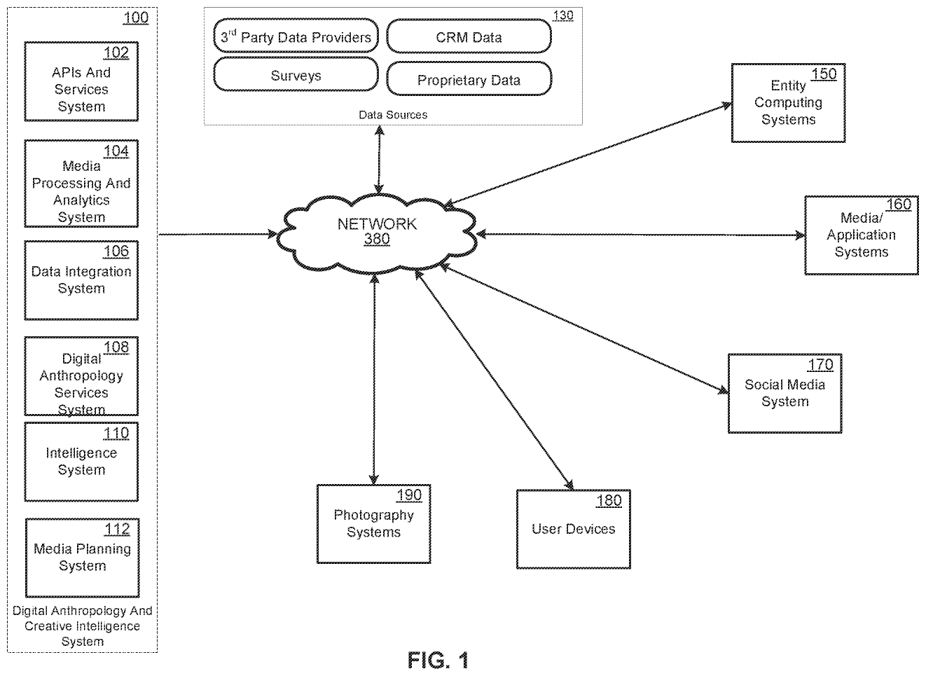

FIG. 1 illustrates an example of a digital anthropology and creative intelligence system 100 according to some embodiments of the present disclosure. The digital anthropology and creative intelligence system 100 may include one or more server computing devices that communicate with a range of computing systems via a communication network. The creative intelligence system 100 may be hosted on a cloud computing infrastructure (e.g., Amazon AWS® or Microsoft Azure®) and/or on a set of physical servers that are under the control of the host, provider, or operator of the digital anthropology and creative intelligence system 100.

In embodiments, the digital anthropology and creative intelligence system 100 analyzes media assets to extract a set of (e.g., one or more) media asset attributes and generates a media asset genome of each media asset based on the extracted set of media asset attributes. In embodiments the genome information of a media asset may be embedded into the media asset. A media asset can be any unit of media, digital media or non-digital media, and may be of, but is not limited to, the following media types: images, audio segments (e.g., streaming music or radio), video segments (e.g., television or in-theatre), GIFs, a video game, a text file, an HTML object, a virtual reality rendering, an augmented reality rendering, a digital display, a news article, a projection/hologram, a book, or hybrids thereof. In some scenarios, a media asset may contain or be associated with advertising content. Advertising content may appear within the media asset or may accompany the media asset (e.g., in a Facebook® post or in a Twitter® tweet). Advertising content may be of the same media type as the media asset or may be in a different media type. For purposes of explanation, advertising content is said to be associated with a media asset if the media asset is used to advertise a product, service, or the like. A media asset genome may refer to a collection of media asset attribute data of a media asset. Media asset attribute data (also referred to as “media asset attributes”) describes characteristics and/or classifications of a media asset. Media asset attributes may be expressly provided by a human, classified by a media asset classifier (e.g., an image classifier, video classifier, audio classifier) and/or extracted from the media asset or the metadata thereof (e.g., location, timestamp, or title) using domain-specific extraction/classification techniques. An example set of media asset attributes pertaining to an image or videos containing a subject (e.g., a model, an actor or actress, an animal, a landscape, etc.) may include, among other attributes, the following: a type or classification of the media asset (e.g., action video, funny video, funny meme, action photo, product advertisement, cute animal photos, etc.); subject types of the subject(s) appearing within the media asset; hairstyles of human subjects appearing within the media asset; clothing styles of subjects appearing within the media asset; identities of individuals involved in making the media asset (e.g., photographer, director, producer, lighting designer, set designer, and others); poses of subjects appearing within the media asset; activities of subjects appearing within the media asset; setting of the media asset (indoors/outdoors, beach/mountains, day/night, and the like); objects appearing within the media asset; fonts or type-styles used in the media asset; font or text-sizes of text within media asset; keywords or phrases used in media asset; location and/or size of subjects and/or objects as depicted in the media asset; background music vocal features of a speaker in the media asset; text fonts and sizes displayed in the media asset; a classification of a text-based message depicted in the media asset (e.g., funny text, inspirational quote, etc.); video segment length; audio segment length; a lighting style or configuration (e.g., a directional lighting style, a type of light source, a color of light, a color temperature of light, or many others); a photographic style or configuration (e.g., use of a filter, color palette, value range, lens, f-stop, shutter speed, film speed, or others); and the like. In embodiments, the creative intelligence system 100 may extract additional attributes from the media assets, such as dimensions and ratios of a subject's face and body and may include those attributes in the genome of the media asset.

In embodiments, a genome may be associated with and/or embedded into the media asset, such that when the media asset is propagated into one or more digital environments (e.g., social media, Etail sites, blogs, websites, mobile applications, marketplaces, streaming services, and the like), clients that display/output the media assets to on-line users may report tracking information to the creative intelligence system 100 relating to the consumption of the respective media assets (e.g., using one or more instructions embedded in a JSON file containing the image). In embodiments, the creative intelligence system 100 may propagate media assets via application systems, media systems 160 and/or social media systems 170 and may receive tracking information indicating actions of on-line users that are presented the media asset and may provide user data relating to the on-line user that was presented the media asset. The creative intelligence system 100 may record the tracking data and the user data, which the creative intelligence system 100 may analyze in combination with the genome of the media asset, tracking data and user data relating to other events involving the media asset, and/or tracking data and user data relating to other media assets, as well as the genomes of those media assets. For example, a client (e.g., a web browser or an application) may report tracking data relating to a media asset (e.g., if a user clicked on, hovered over, scrolled past, scrolled back to, shared, looked at (such as measured by eye-tracking systems), navigated to, downloaded, streamed, played, or otherwise interacted with a media asset) to the creative intelligence system 100. The client may further report user data, such as a user ID (e.g., the user's profile on a social media site, a user's email address or the like), an IP address of the user, a location of the user, a MAC address of the user, and/or the like. The creative intelligence system 100 may utilize the user data, the tracking data, and additional user data and tracking data relating to other events that were reported with respect to the media asset and events relating to other media assets to determine certain attributes that more closely correlate to a user engaging with a media asset (e.g., clicking on, sharing, purchasing an item being advertised using the media asset, and the like).

In an example, the creative intelligence system 100 may classify and propagate a set of images that include a first image that may depict a person on the beach in beachwear, while a second image may depict the same person in a forest wearing flannel. The images may be presented to thousands of users in a marketing campaign, and after receiving and analyzing user data tracking data indicating whether users engaged with the respective images in a positive manner (e.g., clicked on a respective image or bought an item advertised using the respective image) or a negative manner (e.g., scrolled past the respective image, reported the image, disliked the image), and user data indicating, for example, the IP addresses of the users or a location of the user, the creative intelligence system 100 may determine that users expressing or embodying particular digital personas, or users having particular demographic, geographic, psychographic, or other combinations of characteristics, such as “Pacific Northwest hikers” are more likely to engage with images containing subjects wearing flannel and/or depicted in a forest, while users that express other digital personas, demographic characteristics, geographic characteristics, psychographic characteristics, or combinations of characteristics, such as “SoCal surfers” are more likely to engage with photos where the subject is wearing beachwear and/or is depicted on the beach. It is noted that while the label of “SoCal surfers” or “Pacific Northwest hikers” is used in the example, the creative intelligence system 100 does not necessarily label different digital personas or demographics. For example, a group of individuals may be grouped together based on one or more latent attributes that are not necessarily classifiable by a human being.

In embodiments, the creative intelligence system 100 may train and deploy models that analyze behaviors and actions relating to online users and the segments (also referred to as “demographic groups”), digital personas (including Etail customers, social media users, article viewers, and the like), and/or digital villages of those online users. A segment may refer to a market segment and/or to a permanent or semi-permanent group of individuals to which a person belongs, such as an age group, a location, a gender, an education level, a psychographic or personality characteristic, and the like. A digital persona may refer to a classifiable aspect of an online user's personality that is presented by the online user when associating with (e.g., accessing, interacting with, being monitored by, or the like) a digital environment (e.g., a website, a social media platform, an Etail site, an email application, a streaming service, a mobile application, a video game, etc.), whether offline or online, such that the digital persona is classifiable based on one or more attributes or actions of the online user and/or one or more attributes of the digital environment. For example, a person may have a “wine shopper” digital persona if the person is searching for wine, an “on-line troll” persona if the person is engaging in “trolling” activities on social media, a “news consumer” persona if the person is reading a political article, a “seller” persona if the person is selling items on an on-line forum, a “foodie” persona if the person is reading an on-line review of a new restaurant, and the like. It is noted that while the examples above are labeled, the labels are provided for example, and in embodiments, a label may not be applied to the digital personas, but rather the digital persona may comprise a group or cluster of individuals that are clustered together based on a set of common features relating to the attributes of the individuals. A digital village may refer to a grouping of different digital personas that all share one or more specific attributes or that interact with each other, such as by communicating around a topic of interest. For example, members of a “shoes” digital village may include members of a “sneaker collector” digital persona, an “on-line shopper” digital persona, a “fashion blogger” digital persona, and the like. In embodiments, consumers may be enabled to actively place themselves in a digital village. Additionally or alternatively, individuals may be placed in or associated with a digital village based on an analysis of the individuals' behavior vis-à-vis data relating to their on-line activity. In embodiments, individuals may belong to multiple digital villages. Various examples of demographics, digital personas, and digital villages are discussed throughout the disclosure. Except where context indicates otherwise, references herein to “consumers” should be understood to encompass individuals or groups who may be targeted by or interact with campaigns, promotions, advertisements, messages, media assets, or the like, whether or not the individuals or groups actually consume a product or service. These examples are not intended to limit the scope of the disclosure.

In training and selecting models used for various use cases, the creative intelligence system 100 may in embodiments be restricted or governed with respect to comingling data from certain different sources. For example, a user of the creative intelligence system 100 may have capability to access sensitive information that is subject to legal or regulatory constraints, such as personally identifiable information of individuals, sensitive financial information, sensitive health information, sensitive security information, or the like and/or an agreement between a host or an operator of the creative intelligence system and a user or a 3^{rd} party data provider may constrain the conditions under which the creative intelligence system 100 is permitted to combine its data with data provided from other data providers. In another example, data provided from one data source may contain demographic data that is not consistent with demographic data provided from another data source (e.g., the first data source provides demographic data for males or females aged 18-40, while the second data source provides demographic data for males or females aged 18-30 and 31-50), and therefore not combinable. In some embodiments, the creative intelligence system 100 may be configured to generate integrated data based on data from two or more independent sources, when the data from one or more of the independent sources cannot be comingled. In some of these embodiments, the creative intelligence system 100 may multi-base the data from the two or more independent sources. Multi-basing may refer to cross-analyzing data from two or more independent sources (e.g., two distinct databases) wherein parallel calls are executed to the multiple independent sources in response to a query, which may comprise a single, unified query that is directed via the parallel calls or processing threads to the multiple independent sources. In embodiments, multi-basing may be employed using algorithms, such as where each member of the family of algorithms is configured to obtain data from a set of relevant data sources that feed the algorithms.

In embodiments, the creative intelligence system 100 may train one or more models using various types of data pertaining to human behavior, whereby the models are trained to optimize a task associated with a given marketing-related use case (e.g., media planning, content selection, directed targeting, etc.). In embodiments, the use case can be a non-marketing use case. In some of these embodiments, the creative intelligence system 100 may implement a set of N different algorithms to train N different models to handle a particular use case for a particular entity (e.g., business unit or customer). The creative intelligence system 100 may assess the performance of each of the N models and may select the best performing model or set of models given the use case and the particular entity. In some embodiments, the creative intelligence system 100 may perform ensemble modeling to assess the performance of and select the model(s) that best perform for a given use case. Once the best performing model is selected, the model may be deployed for use by the particular entity for a particular use case. In some embodiments, some of the data may pertain to one or more different delivery mediums of advertising content (e.g., social media, television, print media, radio, websites, streaming systems, mobile applications, and the like).

In embodiments, the creative intelligence system 100 communicates with entity (e.g., customer) computing systems 150 (e.g., marketing company systems, consultant systems, corporate systems, etc.), application/media systems 160, social media systems 170, user devices 180, self-contained photography studio systems 190, and the like. An entity computing system 150 may be a computing infrastructure of an organization that utilizes one or more of the creative intelligence system 100 in a client capacity. For example, a marketing company may use the creative intelligence system 100 to determine a media plan for an advertising campaign, whereby the creative intelligence system 100 may leverage a model that was trained to determine marketing plans for the marketing company. Examples of marketing plans may include which media vehicles to use, amounts of money to spend on each respective vehicle, which demographics, digital personas, and/or digital villages to target and which media vehicles/media assets to use when targeting those demographics, digital personas, and/or digital villages. In another example, a consulting company may leverage the creative intelligence system 100 to perform location-specific or demographic-specific AB testing on different types of media assets to determine what type of content should be presented to what type of potential consumers or what attributes should be depicted in media asset to reach certain members of specific demographics, digital personas, digital villages, or the like. Application servers and media systems 160 may refer to computing systems that deliver content and/or application data to on-line users. Examples include websites, search applications, blogging applications, streaming services, mobile applications, video game applications, news applications, retail applications, and the like. Social media systems 170 are a specific type of application systems. Many social media systems 170 allow users to share media assets, such as images, video clips, and/or audio clips. In embodiments, the creative intelligence system 100 may propagate media assets via social media systems 170 and other application/media systems 160 and may obtain tracking data and user data resulting from the propagation of the media assets. Self-contained photography studio systems 190 may refer to media asset automation devices. For example, self-contained photography studio systems 190 at a user's premises may be configured to take a high volume of images of a shoe products under a variety of settings (camera angle, tilt, zoom, lighting properties, and the like) and may leverage the creative intelligence system 100 to determine which of the shoe product images would be most effective in appealing within a particular digital village or to a particular digital persona. Self-contained photography studio systems 190 may be configured to capture various types of media asset (e.g., images, audio, video, and the like) and may automatically adjust configuration settings based on subject(s) and/or object(s) to be captured. For example, the self-contained photography studio systems 190 may be arranged for capturing small objects (e.g., shoes or jewelry) or may be arranged for capturing live human models.

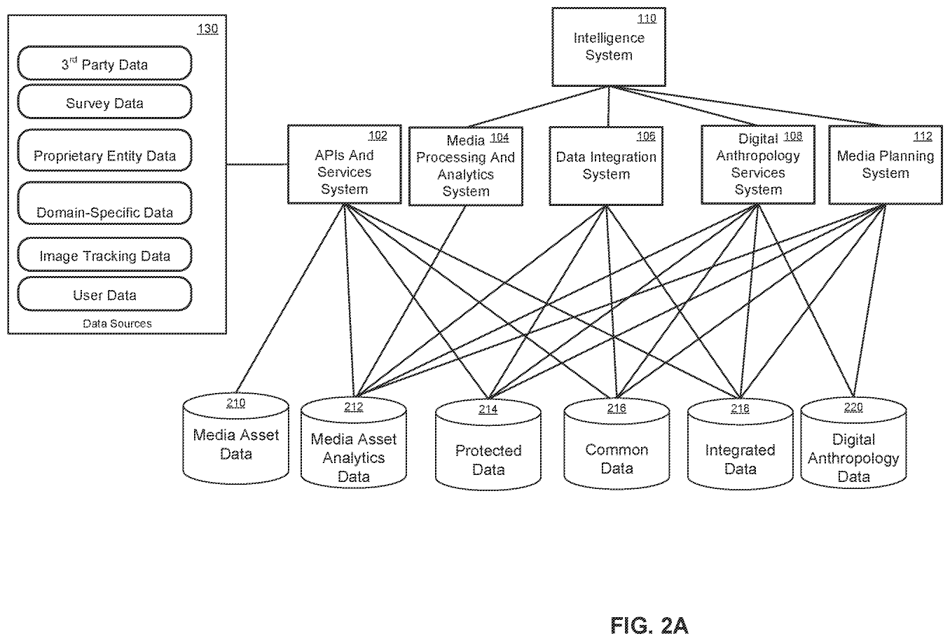

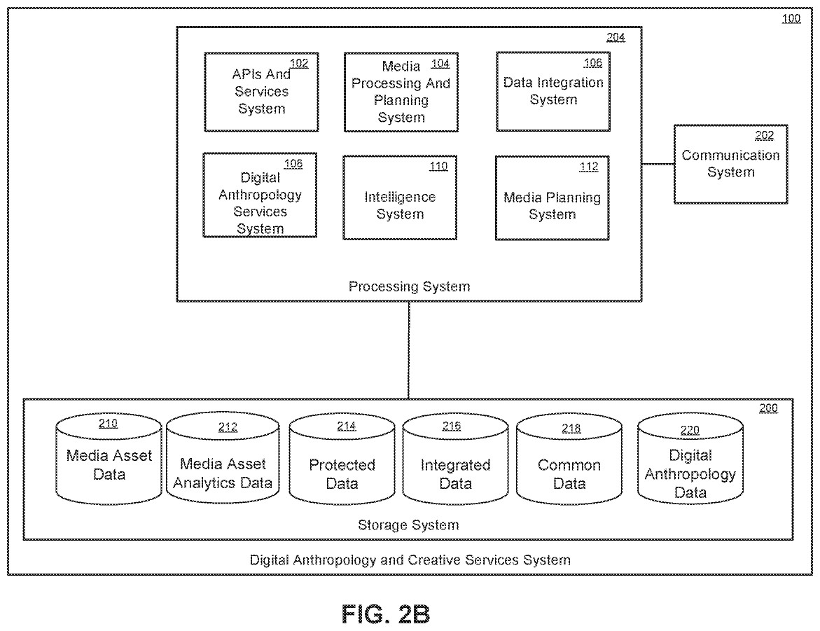

FIG. 2A illustrates an example set of components of the creative intelligence system 100 in relation to the data sources 130 that feed into the creative intelligence system 100. In embodiments, the creative intelligence system 100 may include an API and services system 102, a media processing and analytics system 104, a data integration system 106, a digital anthropology services system 108, and an intelligence system 110, which are described in greater detail below. The creative intelligence system 100 may further include a media asset data store 210, a media asset analytics data store 212, a protected data store 214, an integrated data store 216, a common data store 218, and a digital anthropology data store 220.

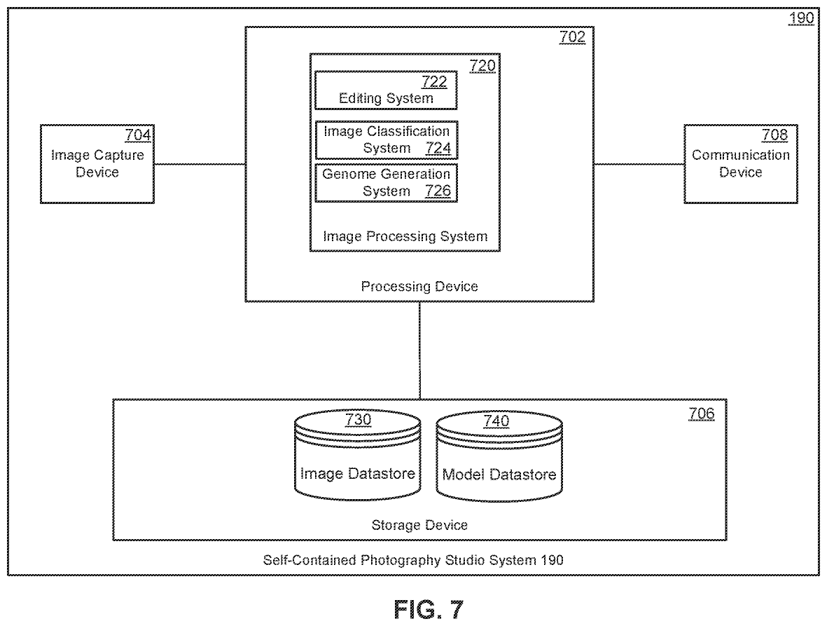

FIG. 2B illustrates an example implementation of a creative intelligence system 100. In embodiments, the creative intelligence system 100 may include a storage system 200, a communication system 202, and a processing system 204. The creative intelligence system 100 may include additional hardware components not shown in FIG. 7.

The storage system 200 includes one or more storage devices. The storage devices may include persistent storage mediums (e.g., flash memory drive, hard disk drive) and/or transient storage devices (e.g., RAM). The storage system 200 may store one or more data stores. A data store may include one or more databases, tables, indexes, records, filesystems, folders and/or files. In the illustrated embodiments, the storage device stores a media asset data store 210, a media asset analytics data store 212, a protected data store 214, an integrated data store 216, a common data store 218, and a digital anthropology data store 220. A storage system 200 may store additional or alternative data stores without departing from the scope of the disclosure.

The communication system 202 includes one or more network devices that are configured to effectuate wireless or wired communication with one or more external devices, including user devices 180 and/or servers, via a communication network (e.g., the Internet and/or a cellular network). The communication system 202 may implement any suitable communication protocol. For example, the communication system may implement an IEEE 801.11 wireless communication protocol and/or any suitable cellular communication protocol to effectuate wireless communication with external devices via a wireless network. The communication system 202 may perform wired and/or wireless communication. The communication system 202 may include Ethernet cards, WIFI cards, cellular chipsets, or the like.

The processing system 204 includes memory (e.g., RAM and ROM) that store computer-readable instructions and one or more processors that execute the computer-readable instructions. The processors may operate in an independent or distributed manner. The processors may be located in the same physical device or may be located in different devices. The processing system 204 may execute one or more of the API and services system 102, the media processing and analytics system 104, the data integration system 106, the digital anthropology services system 108, the intelligence system 110, and the media planning system 112.

In embodiments, the creative intelligence system 100 may receive data from different data sources. The types of data that are received may include, but are not limited to, 3^{rd} party data (e.g., television ratings, commercially available market data, and the like.), thick data (e.g., customer surveys, online surveys, and the like), proprietary client data (e.g., an organization's sales data, an organization's customer data, an organization's media plans, and the like), tracking data relating to a media asset (e.g., instances where a media object was clicked on, looked at, scrolled past, returned to, shared, and the like), and user data that relates to the tracking data (e.g., user IDs, IP addresses, locations, age groups, and/or genders of on-line users that were presented a media asset). In some embodiments, suitable data may be stored using a distributed ledger system (e.g., blockchain) in addition to or in lieu of being stored in the data stores of the digital anthropology system 100.

In embodiments, the media asset data store 210 stores media assets and/or media asset genomes of media assets. In some embodiments, the media asset data store 210 also stores media asset creator-defined metadata and media asset attributes and/or media asset object metadata relating to object(s) appearing in the media asset (e.g., price data for a shoe product being worn by a live model in a media asset). The media asset data store 210 may store other suitable media asset-related data as well.

In embodiments, the media asset analytics data store 212 stores analytical data relating to media assets. In embodiments, the analytical data may include the combination of tracking data of respective media assets and the user data of users that were presented the respective media assets. In embodiments, the analytical data may further include metrics and inferences that were derived by the media asset processing and analytics system 104 based on an analysis of respective sets of media assets, the tracking data relating to the respective sets of the media assets, and the user data of the users that were presented the media assets in the respective sets. For example, the inferences may include which types of attributes of a media asset most correlate with positive actions for individuals belonging to particular demographic groups, particular digital personas, or particular digital villages. The media asset analytics data store 212 may store other suitable analytics data as well.

In embodiments, the protected data store 214 stores data that is restricted in its use. This may include 3^{rd} party data that cannot be comingled with data from other services (e.g., as the result of a licensing agreement) and/or the proprietary data of respective entities (e.g., customers) that can only be used in tasks being performed for that entity. The proprietary data of a respective entity may include personally identifiable information (PII) of their customers or other users, sales data of the customer, marketing data of the entity, models that are trained for use in tasks performed on behalf of the entity, and the like. The protected data store 214 may store any suitable protected data.

In embodiments, the integrated data store 216 stores data that resulted from the integration of data from two or more independent data sources. In some embodiments, the integrated data store 216 stores multi-based data resulting from the multi-basing of data from two or more different independent data stores. The integrated data store 216 may store other suitable data as well, such as data resulting from using data ascription techniques or data fusion techniques on the two or more different independent data sources.

In embodiments, the common data store 218 stores data that may be used without limitation for any tasks. This may include data collected by the creative intelligence system 100 or data provided by 3^{rd} parties that is licensed for common use (e.g., for use by any entity and may be comingled with data obtained from other parties).

In embodiments, the digital anthropology data store 220 stores digital anthropology data that is used in connection with the creative intelligence systems 100 digital anthropology services. Digital anthropology data may include data that defines attributes of different demographics, digital persona data that defines attributes of different digital personas, and/or digital villages that defines attributes of different digital villages, such as behavioral attributes (e.g., browsing behavior, social networking behavior, purchasing behavior, shopping behavior, website navigation behavior, mobile application interaction behavior, mobility behavior, blogging behavior, communication behavior, content consumption behavior, and many others), demographic attributes, psychographic attributes, geographic attributes, thick data, and others, all of which should be understood to be encompassed by use of the terms “attributes” or “demographic” herein, except where context specifically indicates otherwise.

In embodiments, the API and services system 102 provides an interface by which a client application may request and/or upload data to the system 100. In embodiments, the system 100 may implement a microservices architecture such that one or more services may be accessed by clients via application programming interfaces (APIs), data integration systems (e.g., brokers, connectors, ETL systems, data integration protocols (e.g., SOAP), and the like), human readable user interfaces (e.g., web interfaces, mobile application interfaces, and/or interfaces of software-as-a-service (SaaS) or platform-as-a-service (PaaS) systems), and/or software development kits (SDKs). For example, in embodiments, an API or other interface of the creative intelligence system 100 may expose various analytics services that allow users of a client to upload media assets, or identifiers of media assets (e.g., URLs), to the system and/or access analytics relating to the media assets, provide access to sensitive data that cannot be stored at the creative intelligence system 100, upload use cases and algorithms, select or configure a family of algorithms, configure a set of queries, request and view media plans, and the like. In some of these embodiments, the API and services system 102 provides the ability to customize an interface or other client-side capability, such as based on an entity's needs. In some embodiments, the API and services system 102 exposes the services of the media processing and analytics system 104 including a computer vision service, whereby the vision services may, for example, classify uploaded images and/or videos into one or more categories and/or extract objects, faces, and text from images or videos. In embodiments, the creative intelligence system 100 may offer one or more SDKs that allow client developers to access one or more services of the system 100 via the API and services system 102. Example types of SDKs include, but are not limited to: Android, iOS, JavaScript, PHP, Python, Swift, Windows, and/or Ruby SDKs.

In embodiments, the API and services system 102 may receive data from a respective data source and may route the data into the appropriate data store or system. For example, the API and services system 102 may store an incoming media asset in the media asset data store 210 and/or may route the media asset to the media processing and analytics system 102, which in turn may process the media asset and update the media asset data store 210 and/or the media asset analytics data store 212 based on the results of the processing. In this example, the API and services system 102 may further receive tracking data and user data relating to propagated media assets, which the API and services system 102 may route to the media processing and analytics system 104, which in turn may process tracking and user data in relation to the attributes of the respective media assets and update the media asset analytics data store 212 based on the results of the processing. In another example, the API and services system 102 may store 3^{rd} party data that can only be used for certain entities and/or proprietary entity data in the protected data store 214 and/or may route the 3^{rd} party data and/or the proprietary entity data to the data integration system 106, which may multi-base the proprietary entity data with other data collected by the system 100 and may store the results in the integrated data store 216. In another example, the API and services system 102 may receive domain-specific data (e.g., use cases, algorithms, and/or base models) that is to be used to perform a specific task or analysis with respect to a particular vertical or particular entity. The API and services system 102 may route the domain-specific data to the digital anthropology data store 220. The API and services system 102 may receive additional or alternative types of data that the API and services system 102 is configured to handle.

In embodiments, the media processing and analytics system 104 processes media assets to classify one or more attributes of the media assets, extracts additional attributes from the media assets, generates and/or extracts media asset genomes that are associated with their corresponding media asset (optionally including a mix of genome attributes that are associated with the media assets by creators at the time of creation and other attributes that are obtained by processing of the media assets, such as by machine-processing), propagates the media assets into one or more digital environments, tracks actions performed by on-line users presented the media assets in the one or more digital environments, and/or analyzes the actions in relation to the attributes of the on-line users and the media assets. In embodiments, the analytics that are derived from this type of tracking may be used to recommend media objects for use in commercial activities, such as media planning.

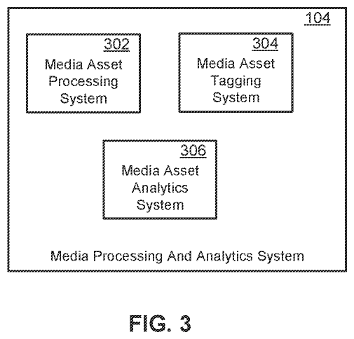

FIG. 3C illustrates a set of example components of the media processing and analytics system 104 according to some embodiments of the present disclosure. In embodiments, the media processing and analytics system 104 includes a media asset processing system 3C02, a media asset tagging system 3C04, and a media asset analytics system 3C06.

In embodiments, the media asset processing system 3C02 analyzes media assets to determine one or more media asset attributes of respective media assets. For example, the media asset processing system 3C02 may be configured to analyze images, video, audio, text, and the like to classify and/or extract attributes thereof using one or more machine-learned models and/or other artificial intelligence-based processes. In embodiments, the training and deployment of machine-learned models and other artificial intelligence-based processes are performed by the intelligence system. In embodiments, the media asset processing system 3C02 may output the attributes to the media asset tagging system 3C04.

In the case of images and/or video, the media asset processing system 3C02 may leverage one or more classification models that are trained to classify one or more elements of an image, video, or other visual media asset. In embodiments, the classification models (e.g., image classification models or video classification models) may be trained using labeled images or videos, wherein the labels may indicate respective classifications of the image or video (e.g., beach image, mountain image, action video, and the like) as a whole, or classifications of a subject of the image (e.g., model is female, model is wearing a swimsuit, model is surfing, model is doing yoga, etc.). A classification model may be any suitable type of model (e.g., a neural network, a convolutional neural network, a regression-based model, a deep neural network, and the like) that can be trained to classify images or videos. In some embodiments, the classification models may be trained on unlabeled images or videos. In these embodiments, the media processing system 3C02 and/or the intelligence system 110 may extract features from the media assets and cluster the media assets based on the extracted features. In these embodiments, “labels” may be assigned to media assets in a cluster based on the dominant features that led to the media assets to be assigned to the respective cluster. In embodiments, the media asset processing system 3C02 may feed a visual media asset to the intelligence system, which leverages one or more classification models to determine classifications of the media asset and/or classifications of one or more elements of the media asset. The classifications may then be attributed to the media asset as media asset attributes thereof. In some embodiments, the media asset processing system 3C02 may perform feature extraction on the visual media assets to extract additional attributes of the media asset.

In the case of audio media assets, the media asset processing system 3C02 may analyze the audio media assets to classify the audio media asset (e.g., a topic of an audio segment). In embodiments, the media asset processing system 3C02 and/or the intelligence system 110 may perform text-to-speech analysis and natural language processing to classify the contents of speech contained in an audio segment. The classifications may then be attributed to the media asset as media asset attributes thereof. In embodiments, the media asset processing system 3C02 may perform audio analysis on an audio segment to identify one or more attributes of the media asset. For example, the media asset processing system 3C02 may analyze an audio segment to identify a tone of a speaker, a gender of a speaker, a pace of the speaker, a song being played in the audio segment, ambient sounds in the audio segment, and the like.

In embodiments, the media asset tagging system 3C04 receives the attributes of a media asset and generates a media asset genome based thereon. The media asset genome may be a data structure that contains the attributes of a media asset. In some embodiments, the media asset genome may include additional data, such as a media asset identifier that relates the genome to the media asset (e.g., a UUID of the media asset) and any suitable metadata (e.g., identifiers of the models used to extract the attributes of the media asset).

In embodiments, the media asset tagging system 3C04 may prepare the image for propagation and tracking. In embodiments, media asset tagging system 3C04 may embed tags and/or code (e.g., JavaScript code) in an image that enables tracking of the usage and distribution of a media asset and the reporting of user data of on-line users that are presented the media asset.

In embodiments, the media asset processing system 3C02 and/or media asset tagging system 3C04 may be used in connection with a user device having media asset capturing capabilities (e.g., digital camera, mobile phone, smart glasses, augmented reality glasses, virtual reality glasses, tablet, laptop, video camera, a microphone, and the like), whereby the user device is configured to classify captured media assets, generate and/or extract media asset genomes for the captured media assets, associate the media asset with the media asset genome, and/or prepare the media assets for propagation and tracking by embedding tags and/or code in the media assets. In these embodiments, the tags and/or code may route the tracking information and/or user data to an API of the creative intelligence system 100. In some embodiments, the user device may be a digital camera (or a user device having a digital camera) embedded with software that automatically generates a genome for each image captured and that associates the genome with the image, such as by capturing device settings associated with the capture of the image, capturing attributes of the environment (e.g., lighting attributes), or the like. In these embodiments, the digital camera may communicate the genome and the image to the creative intelligence system 100 or may propagate the image into a digital environment (e.g., post to social media). In some embodiments the user device may prompt the user, such as a photographer, director, or other content creator, to enter some attributes of the genome, such as on an interface of the user device or on an interface of a connected system, such as a web, mobile or other software interface. For example, the creator may identify the subject of an image, the mood that was intended, the style that was sought, one or more objectives of the image, the brand of clothing or other items that are depicted, and many other attributes.

In embodiments, the media asset analytics system 3C06 performs analytics with respect to media assets based on the genome of one or more media assets, the tracking data relating to the set of media assets, user data relating to the tracking data, and other suitable data. In embodiments, examples of tracking data that may be used by the media asset analytics system 3C06 may include, but are not limited to telemetric data such as a hover state with respect to the media asset, a mouse click with respect to the media asset, a scrolling past the media asset, a download of the media asset, a purchase of an item advertised using the media asset, a viewing time of the media asset, a number of video or audio plays of the media asset, eye tracking with respect to the media asset, scanning behavior with respect to the media asset, facial expressions of the user when presented the media asset, body movements of the user when presented the media asset, sensed physiological data when presented the media asset (e.g., electroencephalogram (EEG), electrocardiography (ECG), electromyography (EMG), blood pressure, body temperature, blood sugar, galvanic skin response (GSR)), and the like. In embodiments, the tracking data may additionally or alternatively include metadata such as location data (e.g., where the media asset was accessed), a timestamp when the media asset was accessed, a device type of the device that accessed the media asset, and/or the like. The tracking data may be collected by any suitable device, such as a web browser, a camera, a microphone of user device presenting a media asset, and/or one or more biometric sensors (e.g., of a wearable device). In embodiments, the tracking data may be collected from other types of environments as well, including but not limited to, smart stores, smart vehicles, smart cities, and the like.

The media asset analytics system 3C06 may perform any suitable descriptive, diagnostic or predictive analytics. For example, the media asset analytics system 3C06 may determine, for a particular media asset or class of media assets, the demographic groups or digital personas that the particular media asset or class of media assets performs the best with (e.g., which demographic or digital persona is most likely to click on the media asset or class of media asset, or purchase a product or service that is advertised using the media asset or class of media asset). In another example, the media asset analytics system 3C06 may determine what type of attributes most positively correlate with positive events given a population (e.g., an entire population, or a particular demographic, digital persona, or digital village).

In embodiments, the media asset analytics system 3C06 may receive a request to perform analysis for a set of media assets. For example, the request may indicate a set of images that were used to individually advertise a common product or service. In response to the request, the media asset analytics system 3C06 may obtain the media asset genome of each image, the tracking data for each image, and the user data corresponding to the tracking data. In these embodiments, the media asset analytics system 3C06 may determine the attributes that most positively correlated with positive events (e.g., user clicked on the image, the user bought a product or service associated with the image, etc.). For example, the media asset analytics system 3C06 may determine that images depicting subjects participating in a particular sport are more likely to result in a positive event than images depicting subjects in traditional model poses. In these embodiments, the analysis may be performed using suitable analytics algorithms. In embodiments user data may be collected with respect to a set of digital personas, digital villages, demographic categories, or the like.

In embodiments, the media asset analytics system 3C06 may present the results of the analytics (e.g., the analytics data) to a user via a creative intelligence dashboard. For example, a user may explicitly request the analytics data from the creative intelligence system 100. In these embodiments, the media analytics system 3C06 may present analytics relating to a campaign, a media asset, and/or customer behaviors via the dashboard. For instance, the media analytics system 3C06 may present graphics, tables, charts, and/or the like that illustrate the correlation between certain media asset attributes (e.g., background, model attire, etc.) and certain user attributes (e.g., age, gender, location, etc.). In embodiments, the media asset analytics system 3C06 may write the analytics data to the media asset analytics data store 212, such that the analytics data may be used in other services, such as segmentation and/or media planning.

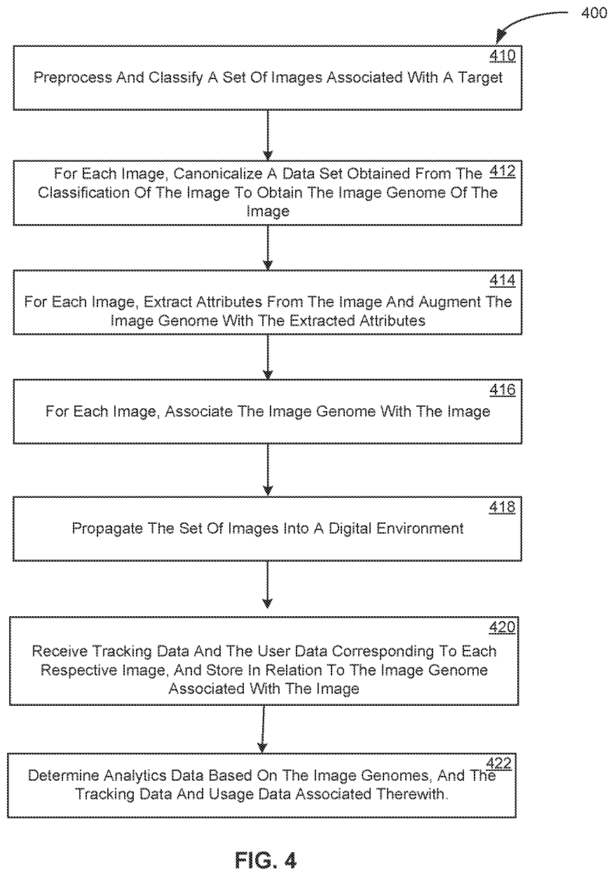

FIG. 4 illustrates an example set of operations of a method 400 for determining analytics data for a set of images. The method is described with respect to the media processing and analytics system 104, but the method may be performed by any suitable computing system without departing from the scope of the disclosure.

At 410, the media processing and analytics system 104 processes and classifies a set of images. In embodiments, the media processing and analytics system 104 may classify the image itself and/or classify one or more aspects of the image. The media processing and analytics system 104 may leverage one or more classification models to determine a set of attributes of the image. In some embodiments, the intelligence system 110 receives the images from the media processing, extracts one or more features of each image and generates one or more feature vectors for each image based on the extracted features. The intelligence system 110 may feed the respective feature vectors into one or more classification models (e.g., image classification models). The classification models, for each feature vector, may output a respective classification based on the feature vector. In some embodiments, each classification may include a confidence score that indicates a degree of confidence in the classification given the classification model and the features of the image. In embodiments, the intelligence system 110 may return a classification of each image to the media processing and analytics system 104 (e.g. the classification having the highest confidence score if more than one classification model is used per image).

At 412, the media processing and analytics system 104 may, for each image, canonicalize a data set obtained from the classification of the images to obtain an image genome of the image. The media processing and analytics system 104 may populate a data structure with the media asset attributes of the image derived from the classification process to obtain an image genome of the image. The media processing and analytics system 104 may canonicalize the data set into an image genome data structure in accordance with a predefined ontology or schema that defines the types of attributes that may be attributed to an image and/or specific classes of images (e.g., landscapes, action photos, model poses, product photos, etc.). In embodiments, the ontology/schema of an image genome may include the entire set of media asset attributes that may be attributed to an image, whereby the data structure corresponding to the image may be parameterized with the attributes of any given media asset.

At 414, the media processing and analytics system 104 may, for each image, extract a set of additional features from the image. The media processing and analytics system 104 may perform various types of feature extraction, including calculating ratios of different elements of a subject, sizes of subject in relation to other objects in the image, and the like. The media processing and analytics system 104 may augment the image genome with the additional extracted features.

At 416, the media processing and analytics system 104 associates, for each image, the image genome with the image. In embodiments, the media processing and analytics system 104 may store a UUID, or any other suitable unique identifier of the image, in the image genome or in a database record corresponding to the image genome.

At 418, the media processing and analytics system 104 propagates the set of images into one or more digital environments. In embodiments, the media processing and analytics system 104 may embed tags and/or code (e.g., JavaScript code) that allows tracking data to be recorded and reported, as well as available user data when the image is presented to a user. In embodiments, the media processing and analytics system 104 may propagate an image by placing the image in digital advertisements, social media posts, websites, blogs, and/or other suitable digital environments. In some embodiments, the media processing and analytics system 104 provides the set of images to a client associated with an entity, such that the entity can propagate the set of images to the digital environments.

At 420, the media processing and analytics system 104 receives tracking data and user data corresponding to each image and stores the tracking data and user data in relation to the image genomes of the images. The tracking data that may be received may include outcomes related to the image (e.g., whether an on-line user purchased an item being advertised using the image, whether the on-line user clicked on the image or a link associated with the image, whether the on-line user shared or downloaded the image, whether the on-line user scrolled past the image, hid the image, or reported the image, and the like). Tracking data may additionally or alternatively include data that describes a behavior of the on-line user when presented with the image (e.g., a heart rate of the user, an eye gaze of the user, a blood pressure of the user, a facial expression of the user, and the like). In embodiments, the user data may be data that explicitly identifies the on-line user (e.g., a username, email address, user profile, phone number of the user). Additionally or alternatively, the user data may be data that provides insight on the user but does not identify the on-line user (e.g., an IP address of the user, a location of the user, an age or age range of the user, a gender of the user, things “liked” by a user on a social media platform, and the like). In embodiments, the media processing and analytics system 104 may store the tracking and user data in the media asset analytics data store 212, such that the tracking data and user data is associated with the image genome of the respective image that was presented to the on-line user.

At 422, the media processing and analytics system 104 determines analytical data based on the image genome of one or more of the images, and the tracking data and user data associated therewith. For example, the media processing and analytics system 104 may determine, for a particular image or class of images (e.g., images having the same classification), the demographic groups or digital personas that the particular image or class of images performs the best with (e.g., which demographic or digital persona is most likely to click on the image, or purchase a product or service that is advertised using the image). In another example, the media processing and analytics system 104 may determine what type of attributes most positively correlate with positive events given a population (e.g., an entire population, a particular demographic, digital persona, digital village, or the like). The media processing and analytics system 104 may present the analytical data to a user via a creative intelligence dashboard or other graphical user interface and/or may store the analytical data media asset analytics data store 212.

The method of FIG. 4 is provided for example only. Variations of the method are contemplated and within the scope of the disclosure. For example, in some embodiments, the media processing and analytics system 104 may generate variations of a single image to obtain different variations of the image. For example, the media processing and analytics system 104 may vary (or may allow a human user to vary) one or more attributes in two or more versions of the image, such as the color of a subject's clothing, the color of a subject's hair, a hairstyle of the subject, or the background depicted in the image, so as to better determine whether a particular attribute better correlates with positive outcomes. In a related example, a user associated with an entity may embed an image having an associated image genome on the entity's website in relation to an item offered for sale. The user may include tags and/or code (e.g., JavaScript code) that are configured to track events with respect to the image and report tracking data based on the tracked events as well as user data of on-line users that are presented the image (e.g., IP address, location, age, and/or gender). The user may further provide an image set containing multiple alternate images that are to be displayed with respect to the same item, whereby the alternate images may then be dynamically switched in and out each time the page is accessed. Genome data, event tracking data, and user data (if available) may then be transmitted to the media asset processing and analytics system, which allows for AB testing using dynamic learning and/or providing recommendations to a user on a creative intelligence dashboard.

Referring back to FIG. 2A, the media processing and analytics system 104 may perform other suitable services. For example, in embodiments, the media processing and analytics system 104 may combine media asset data with first person data (such as e-commerce purchase data) from a third-party data source to determine optimal photography conditions. In embodiments, the media processing and analytics system 104 may operate in connection with a photography-as-a-service that provides photography as a service for entities. In embodiments, the media processing and analytics system 104 may operate in connection with an advertising network (e.g., a persona-based advertising network) and/or a media bidding and buying system (e.g., a persona-based bidding and buying system). The media bidding and buying system may perform fraud detection tasks for detecting fraudulent requests to bid on or buy media opportunities.

The media processing and analytics system 104 may perform additional analytical tasks such as analyzing data sources and re-weighting integrated media studies, reviewing demographic variables among consumers of a product (e.g., “chaid analysis”), cluster analysis, factor analysis (e.g., analyzing the relationship between variables), return on investment (ROI) analysis, television audience ebb and flow analysis, post-campaign delivery analysis, and the like.

Further implementations and examples of media processing, tracking, and analytics are provided in PCT Application Number US2019/049074, filed Aug. 30, 2019, entitled “TECHNOLOGIES FOR ENABLING ANALYTICS OF COMPUTING EVENTS BASED ON AUGMENTED CANONICALIZATION OF CLASSIFIED IMAGES”, the contents of which are incorporated by reference.

In embodiments, the data integration system 106 is configured to integrate multiple sets of data from two or more independent data sources. In some of these embodiments, the data integration system multi-bases the data from the independent data source by cross-analyzing the data from the independent multiple data sources.

In embodiments, the data integration system 106 includes a multi-basing system that cross-analyzes data from multiple data independent sources, wherein the multi-basing system executes parallel calls to the multiple independent data sources in response to a single query. In some embodiments, the multi-basing system can multi-base data from three or more data sources. In embodiments, the multi-basing system may store the results of the multi-basing in the integrated data store 216. Alternatively, the multi-basing system may perform the multi-basing functions on-demand, such that the results of the multi-basing are not stored in integrated data store 216. Examples of multi-basing are discussed in greater detail in U.S. Pat. No. 7,437,307 entitled “A METHOD OF RELATING MULTIPLE INDEPENDENT DATABASES” and in U.S. Patent Application Publication No. 2017/0169482, entitled “CALCULATION OF REACH AND FREQUENCY BASED ON RELATIVE EXPOSURE ACROSS RESPONDENTS BY MEDIA CHANNELS CONTAINED IN SURVEY DATA”, the contents of which are both incorporated by reference in their entirety.

In a specific example of multi-basing, a user may relate or link two independent databases, a first database having demographic data relating to television vehicles (dayparts/channels) and a second database having demographic data related to print vehicles (e.g., magazines, newspapers, etc.) or electronic vehicles (e.g., blogs, websites, news sites, social media, etc.) from a second source. In this example, the multi-basing system tabulates first market rating data (media vehicle viewing levels and audience demographic data) associated with the first database for one or more demographic variables. The multi-basing system then tabulates surrogate market rating data associated with the second database for the one or more demographic variables. In embodiments, the multi-basing system may then determine target group populations for the one or more demographic variables for the second database. The multi-basing system may then calculate a projected vehicle audience for the first database based on the first market rating data associated with the first database and the determined target group populations. The multi-basing system may also calculate a projected surrogate audience for the second database based on the surrogate market rating data associated with the second database and the determined target group populations. Next, the multi-basing system determines an actual surrogate audience. The multi-basing system then provides an output of an actual vehicle audience for the first media vehicle represented by the first database based on the projected vehicle audience for the first media vehicle database, the projected audience for the second media database, and the actual surrogate audience. The foregoing is an example of multi-basing, and the multi-basing system may multi-base other types of data without departing from the scope of the disclosure.

In embodiments, the digital anthropology services system 108 provides insights related to the behavior of humans and human cultures. In some embodiments, the digital anthropology services system 108 implements one or more computational ethnography tools and/or techniques to determine these insights. In embodiments, the digital anthropology services system 108 may identify segments, digital personas, and/or digital villages and understand the behavior of humans having the digital persona or belonging to an identified digital village. For example, the digital anthropology services system 108 may perform analytics on captured text (such as from Twitter®, other social media posts, or the like) and images corresponding to the captured text as an input to determine the sentiment of individuals when discussing the images. In another example, the digital anthropology services system 108 may perform analytics on user interactions with images or videos to determine the sentiment of said users when viewing the images or videos. The digital anthropology services system 108 may analyze other user attributes as well to identify users belonging to digital personas and/or digital villages, such as purchases of users when presented with certain media assets, websites visited by users when shopping for particular types of items, applications used by users when shopping, and the like. In some embodiments, the digital anthropology services system 108 may determine digital personas and/or digital villages of consumers without monitoring individual consumer behaviors. In embodiments, the digital anthropology services system 108 may configure multiple personas as a network target for advertising to which an individual consumer may affiliate.

In some embodiments, the digital anthropology services system 108 (in combination with the intelligence system 108) is configured to test the performance of N artificial intelligence-based algorithms for a specified use case, and select an algorithm (and/or a machine-learned model) to leverage for the specified use case (e.g., a user-defined task) from the set of N algorithms based on the performance of each of the N algorithms for the particular use case based on training data from multiple data sources.

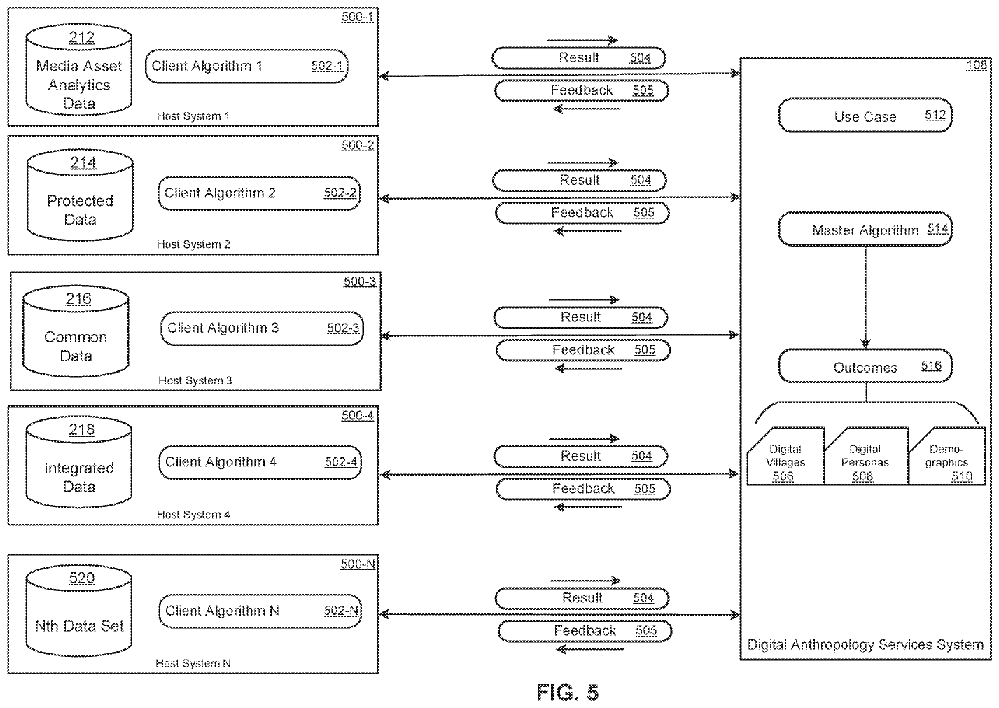

FIG. 5 illustrates an example of an algorithm optimization architecture that may be implemented by the digital anthropology services system 108. In the illustrated example, the digital anthropology services system 108 is configured to optimize a set of N domain-specific client algorithms 502-1, 502-2 . . . 502-N (generally referred to as client algorithms 502) for a particular use case 512 to perform a marketing-related task on behalf of a client. Examples of marketing-related tasks may include customer segmentation, topic modeling/natural language processing, market planning, or the like. In embodiments, the client algorithms 502 are machine-learning algorithms that perform machine learning tasks, such as feature extraction, clustering, recursively training models, and/or the like.

One issue that arises, however, is that the inferences, classifications, and/or predictions obtained from a trained machine-learning and/or artificial intelligence algorithm are dependent on the richness and diversity of the underlying data used to train the machine-learning and/or artificial intelligence algorithm. Modern consumer and enterprise users generate a large amount of data at the network edge, such as sensor measurements from Internet of Things (IoT) devices, images captured by cameras, transaction records of different branches of a company, etc. Such data may not be shareable with a central cloud, due to data privacy regulations and communication bandwidth limitation. In many scenarios, the data that may be used to improve the performance of the machine-learning and/or artificial intelligence algorithm may be stored in different data stores that are under control of different parties, and in some scenarios, this data may be protected data, such as personally identifiable information, restricted data, proprietary data, sensitive data, or the like. For example, an organization that produces soft drinks may utilize the digital anthropology services system 108 for a particular use case 512 (e.g., customer segmentation, market planning, or the like). In this scenario, the soft drink manufacturer may benefit from having access to third party data (e.g., the sales data of fast food chains that serve the soft drink), which the fast food chain may not wish to provide to the soft drink manufacturer despite having a business incentive to help the soft drink manufacturer. Similarly, the soft drink manufacturer may benefit from having vending machine sales data from different geographic locations, whereby in this scenario vending machine data from different locations may be stored in different data stores at different physical locations. In another scenario, two business departments of the soft drink manufacturer may not have access to the other respective department's data (e.g., sales data and marketing data).

To improve the performance of the machine-learning and/or artificial intelligence algorithms deployed by the digital anthropology services system 108 while allowing entities and individuals to maintain control of their data, the digital anthropology services system 108 distributes a set of client algorithms 502 to N respective hosts 500 and executes a master algorithm 514 that optimizes the client algorithms (e.g., optimizing models being trained by the client algorithms) based on results 504 of training performed by the respective hosts 500. As used herein, a host 500 may refer to any suitable computing environment/device that includes one or more processors and data storage and that can communicate with the digital anthropology services system 108. In embodiments, the hosts 500 may include mobile devices in the consumer setting, local servers, cloud datacenters in the enterprise or cross-organizational setting, and the like. A host 500 may store or have access to a respective data set that belongs to the customer (e.g., analytics, crawled data, media asset analytics, and the like) or another entity (e.g., sales data of a trade partner of the customer, data sets provided by third-party data collectors, data from social media platforms or other content platforms, telemetric data from a user device).

In embodiments, the digital anthropology services system 108 distributes a set of client algorithms 502 to N respective hosts, whereby each respective host 500 executes the client algorithm to 502 to train a local machine learned model. In these embodiments, the master algorithm 514 works in combination with the respective hosts to train a global model in a distributed manner (e.g., based on the training of the local machine learned models). In the illustrated example, the client algorithms 502 may be executed by a first host 500-1 that stores a media asset analytics datastore 212, a second host 500-2 that includes protected data 214 (e.g., third-party data stored on third-party servers), a third host 500-3 that stores common data 216 (e.g., data collected by a web crawler from publicly available data sources), a fourth host 502-4 that stores integrated data 218 (e.g., data resulting from multi-basing two or more separate data sources) . . . and an Nth host that stores an Nth type of data. It is understood that the foregoing list is provided for example only, and other suitable types of data or scenarios may be supported. For example, an organization may have different data centers in different parts of a country, whereby the data stored in each data center corresponds to a different geographic location. In this scenario, each respective data center may be a respective host 500 that stores the data corresponding to its respective geographic region. In embodiments, distributing the client algorithms 502 to the different data hosts 500 allows the digital anthropology system 108 to distribute the training of the client algorithm across different data sets, with potentially different owners of the disparate data sets.

In embodiments, the master algorithm 514 does not have access to any of the data sets of a host 500. In some of these embodiments, the master algorithm 514 receives results 504 from each host 500 (e.g., determined model weights after a training iteration) and synchronizes the results 504 from the sets of hosts 500 into a global model that is used in connection to the use case 512. In some embodiments, the master algorithm may be configured to formalize feedback 505 that is used by the client algorithms 500 for meta learning. In some of these embodiments, the master algorithm 514 determines the feedback 505 in response to testing the global model by providing a validation data set using representative data (which may be obtained as the global model is used, from a training data set, and/or from a human, such as a data scientist or the customer). As the error rates resulting from the local models trained by the client algorithms 502 converge, the performance of the global model maintained by the master algorithm 514 improves. In this way, individuals, organizations, and/or other third parties may protect and keep private their proprietary data, while assisting the customer for the particular use case.

In embodiments, each of the N client algorithms 502 may be embodied as executable code (e.g., a set of executable instructions) that perform the same algorithm on a different data set. In embodiments, each respective client algorithm 502 of the N domain-specific algorithms is deployed to a respective host 500. For example, a user affiliated with a customer may define and/or select the client algorithm 502 and may designate the hosts 500 on which the client algorithm 502 will execute. In response, the platform 100 may distribute the client algorithm 502 to the respective hosts 500, whereby each client algorithm 502 may be downloaded to, installed on, and/or executed by the respective host 500.

In embodiments, the client algorithms 502 may implement one or more machine learning and/or artificial intelligence processes and may leverage one or more machine learned models to provide a result requested by the master algorithm 514. For example, the client algorithms 502 may implement classifiers, clustering, pattern recognition, reinforcement learning, attribution, natural language processing and natural language understanding, segmentation, prediction, particle swarm optimization, recommender super learning, and the like. In embodiments, each of the client algorithms 502 trains a local version of a model, where each local version is initially parameterized in the same manner. For example, if the client algorithm 502 includes training a neural network, the weights associated with each of the nodes of the neural network is parameterized in the same manner across the different hosts 500. As each respective client algorithm 502 executes with respect to the data set stored (or accessible) by the corresponding host 500, the respective client algorithm 502 will adjust the parametrization of the local model (e.g., the parameterization of a neural network, regression model, random forest, etc.) based on the data set hosted by the corresponding host 500. In some embodiments, each client algorithm 502 may initially determine a training data set from the data set stored on (or accessible by) the respective host 500. The client algorithm 502 may then execute on the training data set to parameterize the local version of the model. In some of these embodiments, the client algorithm 502 may also receive a validation set, whereby the validation set is used by the client algorithm 502 to validate/error check the accuracy of the local model during or after training.

As a client algorithm 502 executes, the client algorithm 502 may provide results 504, such as the determined weights of the local version of the model or an output of the local version of the model, to the master algorithm 514. In response, the client algorithm 502 may receive feedback 505 from the master algorithm 514, which the client algorithm 502 uses to reinforce/update the local version of the model. The client algorithm 502 may reinforce/update the local version of the model to reduce the error rate of the local version of the model. In some embodiments, each client algorithm 502 may perform local stochastic gradient descent (SGD) optimization.

In embodiments, the master algorithm 514, which is configured to optimize outcomes 516 with respect to a particular use case 512 by integrating the results 504 provided by the different client algorithms 502 into a global model. For example, if the use case 514 is customer segmentation, the master algorithm 514 may be configured to identify digital villages 506, digital personas 508, and/or demographic groups 510 that are relevant to a customer's business. As the hosts 500 and the master algorithm 514 execute and train the global model, the global model may be leveraged by the digital anthropology services system 108 (and/or other systems, such as the intelligence system 110) in connection with a market-related task (e.g., market planning, customer segmentation, topic modeling, or the like). In embodiments, the digital anthropology services may receive a request to perform a marketing-related task, whereby the request may include data relating to the use case. For example, a request may include features of an individual and may request a classification of the individual with respect to a digital village 506, a digital persona 508, and/or demographic group 510. In response, the digital anthropology system 108 may leverage the global model to service the request. In doing so, the digital anthropology system may issue an outcome 516 to the requesting system. In some embodiments, the digital anthropology system 108 may monitor events that occur in relation to the outcome, whereby the digital anthropology system 108 may reinforce the global model by providing feedback 505 to the hosts 500 based on the monitored events.

In embodiments, the digital anthropology services system 108 may be configured to support distributed learning techniques, such as parameter server and federated learning. Parameter Server (PS) may refer to an approach to support distributed training by introducing a central node which manages one or more shared versions of the parameters of the whole model. Examples of PS implementations are discussed in “Scaling Distributed Machine Learning With The Parameter Server”. Mu Li, Carnegie Mellon University and Baidu; David G. Andersen and Jun Woo Park, Carnegie Mellon University; Alexander J. Smola, Carnegie Mellon University and Google, Inc.; Amr Ahmed, Vanja Josifovski, James Long, Eugene J. Shekita, and Bor-Yiing Su, Google, Inc., the contents of which are incorporated by reference. Federated learning (FL) is a framework for training machine learning models using geographically dispersed data collected locally. Examples of federated learning are discussed in greater detail in “Federated Topic Modeling” Di Jiang, Yuanfeng Song, Yongxin Tong, Xueyang Wu, Weiwei Zhao, Qian Xu, and Qiang Yang. 2019, the contents of which are incorporated by reference.

In embodiments, a federated learning approach may include local computation across multiple decentralized edge hosts 500, whereby the hosts 500 participate in training a central machine learning model during synchronization phases. In embodiments, federated learning enables text, visual and interaction models to be trained on hosts 500, bringing advantages for user privacy (data need never leave the device), but challenges such as data poisoning attacks. In embodiments, the basic process of federated learning includes local model building and error gradient computation at the host level and then model parameter aggregation (or averaging) by a server (e.g., the digital anthropology services system 108). In embodiments, the master algorithm 514 is executed by the digital intelligence services system 108 to perform model parameter aggregation. Instead of sharing the raw data, only model parameters and gradients need to be shared between hosts and the master algorithm 514.

In embodiments, the master algorithm 514 integrates the results 504 transmitted from the hosts 500 (e.g., the weights of the local versions of a models) into a global model and formalizes the necessary information for meta learning in the next iteration. The master algorithm 514 may implement suitable machine learning/deep learning algorithms and is suitable for scenarios where data is not independent-and-identically distributed across parties, with some enhanced processes involved.

An example of a federated learning approach is Federated Averaging (FedAvg). In embodiments, each host 500 may download or may otherwise receive the same starting local version of a model from a central server (e.g., the digital anthropology services system 108) and may perform local stochastic gradient descent (SGD) optimization, minimizing the local error over local samples of data (e.g., data stored by the respective host) with a predefined learning rate, for a predefined number of epochs before sending the results (e.g., accumulated model weights) back to the digital anthropology services system 108. In embodiments, the master algorithm 514 then averages the results 504 from the reporting hosts 500 with weights proportional to the sizes of hosts' local data and finishes a federated round by applying aggregated updates to the starting model at the predefined learning rate. It is noted that alternative optimizers may be applied with great success for the problems of bias, non-independent-and-identically-distributed (IID) data, communication delays, and the like.

In embodiments, the master algorithm 514 optimizes the local versions of the model using a multi-prong approach. When the data distributed across the hosts 500 converges on becoming IID, then the master algorithm 514 may determine the model parameters for each candidate algorithm by performing, for example, a weighted averaging of all of the model parameters received from the hosts 500. When the distributed data is less balanced (e.g., some hosts have much more data than others) and/or as the content distributions become more diverse (e.g., non-IID), the master algorithm 108 may determine the model parameters using representative data. Assuming that there is a general idea of the potential data stored on the hosts 500 and that there is representative data available (e.g., as obtained from historical data or from an expert), the master algorithm 514 can partially train the base model using the representative data as training data and then may distribute both the base model and the representative data to all of the hosts 500. The representative data contains examples from each demographic, digital village, digital persona, class, category, or topic to be modeled. Each is randomly sampled into the local host data and used as part of the local training/validation data.

In embodiments, the digital anthropology services system 108 may be configured to support decentralized training of models. Decentralized training may allow point-to-point communication between hosts 500 by specifying a communication graph that mitigates the need for the master algorithm 514 in a static location. It is noted that decentralized training may still requires a process that initiates the decentralized training. In embodiments, the digital anthropology system 108 may implement PS and/or All-Reduce, which may support the use of a specific communication graph. In decentralized training, every host 500 maintains its own version of the model parameters, and only synchronizes with the other hosts 500 according to the communication graph. As training proceeds, local information at a host 500 propagates along edges of the communication graph and gradually reaches every other host 500.

Referring back to FIGS. 1, 2A, and 2B, in embodiments, the intelligence system 110 performs various cognitive tasks in support of the creative intelligence system 100. Cognitive tasks may include, but are not limited to, recommendations, analytics, computer vision, machine-learning, artificial intelligence, and the like.

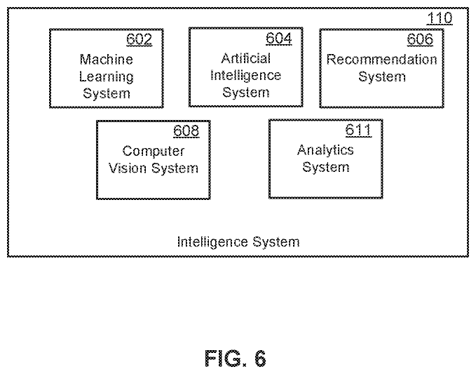

FIG. 6 illustrates an example set of components of the intelligence system 110, including a recommendation system 606, a computer vision system 608, a machine-learning system 602, an artificial intelligence system 604, and an analytics system 610, a visualization system.

In embodiments, the machine-learning system 602 may train models, such as predictive models and classification models. These models may include any suitable type of model, including various types of neural networks, regression-based models, decision trees, random forests, and other types of machine-learned models. Training can be supervised, semi-supervised, or unsupervised. Training can be done using training data, which may be collected or generated for training purposes.

In embodiments, the machine-learning system 602 may train one or more models with one or more data sets. For example, the machine-learning system 602 may train a media asset prediction model. In embodiments, a media asset prediction model may be a model that is trained using media asset genome data, demographic data, and outcome data relating to different combinations of genome data and demographic data. In these embodiments, a media asset prediction model may receive a data structure (e.g., a feature vector) containing media asset genome data and demographic data of an individual and may predict an outcome based on the received data structure, whereby the predicted outcome may relate to an effectiveness of the media asset (e.g., as an advertisement for a brand) given a particular demographic segment. Examples of predictions may be whether the demographic segment may favor a particular version of a media asset, whether the demographic segment will purchase the product being advertised in the media asset such that sales metrics are met, and the like.

In embodiments, the machine-learning system 602 trains models based on training data. In embodiments, the machine-learning system 602 may receive or generate vectors containing media asset genome data (e.g., subject hairstyle, beach setting, bathing suit, and the like), demographic data (e.g., age, gender, location, and the like), and outcome data (e.g., user purchases product displayed in the media asset, user flags the media asset, and the like). Each vector corresponds to a respective outcome and the respective attributes of the respective media asset and respective demographic segment corresponding to the respective outcome. Once the model is in use (e.g., by the artificial intelligence system 604) training can also be done based on feedback received by the machine-learning system 602, which is also referred to as “reinforcement learning”. In embodiments, the machine learning system 602 may receive a set of circumstances that led to a prediction (e.g. beach setting) and an outcome related to the media asset (e.g. user purchases product displayed in the media asset).

Non-limiting examples of machine-learning techniques include, but are not limited to, the following: decision trees, K-nearest neighbor, linear regression, K-means clustering, neural networks, deep learning neural networks, convolutional neural networks, random forest, logistic regression, Naïve Bayes, learning vector quantization, support vector machines, linear discriminant analysis, boosting, principal component analysis, hybrids of K-means clustering and linear regression, and/or other hybrid offerings. Machine-learning/artificial intelligence algorithm reasoning types may include inductive reasoning and deductive reasoning.

In embodiments, the artificial intelligence system 604 may leverage the machine learned models (e.g., prediction models and/or classification models) to make predictions regarding media asset outcomes with respect to media asset genome data, demographic data, interaction data, digital personas, digital villages, financial data, health data, traffic data, identity management data, customer data, digital anthropology data, and the like. In some embodiments, the artificial intelligence system 604 may leverage a model trained by the machine learning system 602 to analyze different versions of a media asset and to advance versions of the media asset that will result in favorable outcomes.

In embodiments, the artificial intelligence system 604 may be configured to create and update individual digital profiles of consumers using 3^{rd} party person data and/or other consumer-related data. Digital profiles of consumers may be a data structure containing attributes of individual consumers (e.g., age, location, gender, interests, education, employment, income, relationships, and the like).

In embodiments, the artificial intelligence system 604 may be configured to determine optimal media asset attributes so as to optimize sales metrics, appeal to a specific digital persona, or the like. In some of these embodiments, the artificial intelligence system may leverage a machine-learned model and/or analytics derived by the analytics system 610 to determine the optimal media asset attributes to depict in a media content asset. In embodiments, media asset attributes may be subject and/or object placement within a media asset, subject(s) appearing in the media asset (e.g., potential brand ambassadors that are liked best by a specific digital persona or demographic segment), text appearing within or associated with the media asset, audio appearing within or associated with the media asset (e.g., song), the premise of the media asset, and the like. In embodiments, the artificial intelligence system 604 may be trained to generate an automated media asset based on determined optimal media asset attributes.

In some embodiments, the artificial intelligence system 604 may leverage a machine-learned model that is trained to identify and flag sensitive advertising inventory or advertising spots available in connection with the media bidding and buying system. For example, the machine-learning system 602 may train models with a set of images that have been selected as sensitive advertising inventory and/or advertising spots, and the artificial intelligence system 604 may leverage the model to flag available advertising inventory associated with a show (e.g., when an actor on the show is embroiled in a scandal). In some embodiments, the machine-learning system 602 and/or artificial intelligence system 604 may be trained to identify and flag sensitive media assets (e.g., violence, adult, medical procedures, and the like). For example, the machine-learning system 602 may train models with a set of images that have been selected as sensitive media assets (e.g., containing violence, racism, adult content or the like) and the artificial intelligence system 604 may leverage the model to flag newly provided media assets that contain similar content.

In embodiments, the artificial intelligence system 604 may be configured to optimize presentation attributes associated with the media asset (e.g., presenting the media asset in a television advertisement for a specific show, presenting the media asset in a specific magazine, presenting the media on a smartwatch, and the like). In some of these embodiments, the machine-learning system 602 may train models that predict advertisement effectiveness for each pairing of an advertisement and a media instance (e.g., television show) based upon a combination of the ad effectiveness measures and the number of previously placed airings of the advertisement in the media instance. In some of these embodiments, the artificial intelligence system 604 may leverage these models to determine factors leading to poor performance (e.g., low sales metrics for a product advertised in media asset) of the media asset in an advertising campaign or unexpected results of the media asset in an advertising campaign (e.g., unexpected digital personas purchased the product in amounts exceeding pre-determined sales metrics). In embodiments, the artificial intelligence system 604 may be configured leverage models (e.g., trained by the machine learning system 602) to determine factors leading to high performance of the media asset in an advertising campaign and/or to develop consumer path to purchase models.

In embodiments, artificial intelligence system 604 may be configured to determine optimal pricing for a product advertised in the media asset and may use dynamic pricing techniques or the like in such a determination. In some of these embodiments, the artificial intelligence obtains analytic data from the analytics system to determine different purchasing trends for different demographic groups, digital personas, and/or digital villages. In embodiments, the artificial intelligence system may utilize a rules-based approach that takes into account the analytics and the set of features of a consumer or group of consumers to determine a dynamic price for a product that is presented to a consumer exhibiting the set of features. In some embodiments, the machine-learning system 602 may train one or more price prediction models that predict the highest price a consumer will pay for a product given a set of features. In these embodiments, the machine-learning system 602 may receive training data indicating outcome data (e.g., previous purchase prices or rejected prices) and features relating to the outcome (e.g., features of respective consumers, digital personas, or digital villages), whereby the price prediction models receive a set of features relating to a consumer (or group of consumers, such as a digital persona or digital village) and outputs a price for a product. In some embodiments, such models are trained for specific products. Alternatively, a generic model can be trained using outcomes (e.g., price paid for a product or price declined) and corresponding product-related features and consumer-related features. In these embodiments, the model may receive product-related features and consumer-related features and may output a price given the set of features. In embodiments, the machine-learning system 602 and/or artificial intelligence system 604 may be trained to determine optimal packaging attributes for a product (e.g., packaging material, design, colors and the like).

In embodiments, the artificial intelligence system 604 may be configured to curate content relevant to a particular topic or area of interest (e.g., competitor data). In embodiments, the machine-learning system 602 trains content prediction models that are trained to determine product or service competitors for a product or service being advertised in a media asset based on competitor-related data (e.g., retail locations, products available, pricing, and the like). According to some embodiments, the artificial intelligence system 604 may leverage these models to determine merchandise or services to make available at a retail location that may be based at least in part on data related to competitors (e.g., retail location distance from a competitor retail location, products available at competitor retail location, or the like).

In embodiments, the artificial intelligence system 604 may be configured to identify and extract relevant features of digital villages and/or digital personas. In some of these embodiments, the artificial intelligence system may be trained to update digital village data and digital persona data.

In embodiments, the machine-learning system 602 and/or artificial intelligence system 604 may be configured to predict consumer behavior and/or emotions (e.g., habits, personality traits, needs, desires, and the like).

In embodiments, the machine-learning system 602 and/or artificial intelligence system 604 may be trained to characterize and optimize a trend based on analysis of style of a set of trending media assets.

In embodiments, the machine-learning system 602 and/or artificial intelligence system 604 may be trained to determine advertising targets for a particular advertising campaign wherein the advertising targets may be a specific demographic segment, a digital village, a digital persona, or the like. The machine-learning system 602 and/or artificial intelligence system 604 may be trained score and rank potential advertising targets.

In embodiments, the machine-learning system 602 and/or artificial intelligence system 604 may be trained to predict a user's demographic information using at least in part data collected from the user's interactions in a digital environment.

In embodiments, the intelligence system 110 may include a recommendation system 606 for providing recommendations related to media asset attributes, media planning, media pricing, and the like. In embodiments, the recommendation system 606 leverages the artificial intelligence system 504 to determine recommendations relating to media asset attributes, media planning, media pricing, and/or the like. In embodiments, the recommendation system 606 receives requests from a client device for a recommendation, such as a recommendation of media asset attributes given a demographic, digital persona, or digital village. In response, the recommendation system 606 may leverage the artificial intelligence system 604 using the contents of the request to obtain a recommendation. The recommendation system 606 may return the recommendation to the requesting client device or may output the recommendation to another system (e.g., the media planning system 112 or the digital anthropology services system).

The intelligence system 110 may include a computer vision system 608 for providing computer vision services, whereby the vision services may, for example, classify uploaded images and/or videos into one or more categories and/or extract objects, faces, and text from images or videos. In embodiments, the computer vision system 608 may receive a media asset, such as a video or an image, and may extract a set of media asset features of the media asset and may classify one or more aspects of the media asset. For instance, the computer vision system 608 may classify the type of scene depicted (e.g., beach front, in-studio, mountains, etc.), the subjects and/or objects depicted (e.g., models, landscapes, gym equipment, etc.), clothing types worn by models (e.g., winter clothing, beach clothing, revealing clothing, etc.), and/or other aspects of the media asset. In embodiments, the computer vision system 608 may leverage one or more machine-learned image classification models that are trained to classify images (or time-sequences images, such as a video) and/or aspects of the images (or time-sequences of video). In embodiments, the computer vision system 608 may output classifications to another system, such as the intelligence system 604, the machine-learning system 602, the analytics system 610, the recommendation system 606, or the like.

In embodiments, the intelligence system 110 may include an analytics system 610 that collects, tracks, and/or analyzes data collected by the system 100. In embodiments, the analytics system 610 may also enable users to monitor advertising campaigns, advertising campaign data, data availability, data consistency, and the like. The analytics system 610 may also enable users to generate custom reports or may generate automatic reports related to advertising campaigns, media assets, data, and the like.

In embodiments, the analytics system 610 generates data visualizations. In some embodiments, the analytics system 610 may generate data visualizations on behalf of a customer (e.g., in response to a request from a client to view a data visualization) and may present the data visualizations to the user via a creative intelligence dashboard. Data visualizations may include, but are not limited to, crosstabulation database visualizations, crosstabulation results (“p-map”), digital anthropology services visualizations (ethnographic heatmaps or “ethnoarrays”, social network analysis (SNA), and the like), simulations, and digital mood boards (e.g., displaying a collection of visual elements relating to a specific mood, theme persona, digital village or the like). In embodiments, the creative intelligence dashboard may display media asset attribute data as it relates to geographic locations. For example, the analytics system 610 may obtain media asset tracking data relating to a set of media assets of a customer and may determine trends relating to demographics, digital personas, and/or digital villages, such as geographic locations where subjects are dressed in athletic wear are favored/lead to more sales vs. geographic locations where subjects dressed in professional wear are favored/lead to more sales. In this example, the creative intelligence dashboard may display geographic locations (e.g., states, regions, countries, or the like) and the user engagement with the various types of media assets. In embodiments, the analytics system 610 may support connected reality tasks by enabling data visualizations or other types of data interaction in a virtual reality environment, which may be accomplished using a head-mounted display for immersion and virtual reality controllers for interaction.

In embodiments, the analytics system 610 may be configured to learn attributes (e.g., media asset preferences) of specific demographics (e.g., consumers residing in the Midwest, consumers over the age of 65, consumers that are female, and/or the like), digital personas, and/or digital villages. For example, in some embodiments, the analytics system 610 may cluster individuals (e.g., users) using a suitable clustering algorithm (e.g., K-means clustering, K-nearest neighbor clustering, or the like) to identify relevant demographics, digital personas, and/or digital villages.

According to some embodiments, the creative intelligence system 100 includes a media planning system 112. In embodiments, the media planning system enables users to plan advertising campaigns based on demographics and/or received consumer markets, audience, and cost data. The media planning system 112 may include or leverage any number of media planning services. In embodiments, the media planning system 112 receives a request to generate a specific type of media plan from a client device associated with a customer. In response, the media planning system 112 may generate cost, reach, and/or frequency reports that indicate market average reach and frequency evaluations based on the features of the customer (e.g., industry vertical, budget, target demographics, and/or the like). In embodiments, the media planning system 112 generates target audience reach and frequency delivery estimation models. In embodiments, reach and frequency may be calculated based on tracking data relating to a media asset across all digital and traditional platforms.

In embodiments, the media planning system 112 may convert audience and schedules into reach and frequency estimates for every medium in an advertising schedule.

In embodiments, the media planning system 112 is configured to map a facility to provide customized ‘intelligent geographic information”. In these embodiments, the media planning system may utilize enhanced geographic information, such as a detailed site level information, to customize the intelligent geographic information (e.g., for out of home advertising). The media planning system may be further configured to perform services relating to inventory management, customizable site packages, target audience selection, and/or panel and audience selection.

In embodiments, the media planning system 112 may enable users to plan advertising campaigns based on advertising type (e.g., outdoor advertising, video streaming advertising, in game advertising, and the like). In embodiments, planning for outdoor advertising may be based on detailed site level and market average reach and frequency evaluation using TAB OOH (Traffic Audit Bureau Out of Home) ratings. In embodiments, users may be enabled to plan media campaigns in a number of different manners. For example, users can plan by GRPS (e.g., determine how many sites are needed). In this example, the behavioral targeting of digital media can be expressed in the traditional coverage terms—Gross Ratings Points (GRPs)—used to evaluate multimedia campaign performance. In another example, users can plan by panel based on the GRPs delivered. In another example, users can plan by reach goal (e.g., within a number of weeks, to return the number of panels, by operator). Users may combine outdoor planning results with other media schedules for media mix evaluations. Media mix evaluations estimate the impact of various marketing tactics (marketing mix) on sales.

In embodiments, the media planning system 112 performs cross-media planning that enables users to generate media plans across multiple media types based on demographics and/or received consumer markets, audience, and cost data.

In some embodiments, the media planning system 112 may provide an audience planning service that analyzes audience variables, identifies audience variables with highest relevance to predetermined brand goals, and/or applies predictive analytics and causality to recommend audience segments and combinations of media. In these embodiments, the audience planning service recommends audience segments and media combinations to engage a brand's best customers across digital and traditional platforms. In embodiments, the audience planning service may analyze audience variables, distill variables down to those most pertinent to brand goals, apply predictive analytics and causality to recommend audience segments with the greatest customer potential, and specify combinations of media that will best engage said audience segments. In some embodiments, these recommendations include audience specifications that can be provided to demand side platforms (DSPs). Audience variables may include, but are not limited to, demographics variables, attitudinal variables, customer lifestyle variables, product usage variables, and/or digital behavior variables. In some embodiments, the audience planning service can conduct audience measurement around a geolocation.

FIG. 7 illustrates an example configuration of a self-contained photography studio system 190 according to some embodiments of the present disclosure. The self-contained photography studio system 190 may be implemented on any suitable device (e.g., mobile device, tablet device, dedicated camera, web camera, a personal computing device having a camera, or the like) that can capture images and can connect to a network. In embodiments, the hardware components of the self-contained photography system may include a processing device 702 having one or more processors, an image capture device 704 that includes at least one lens, a storage device 706 that includes one or more non-transitory computer readable mediums, and a network communication device 708 that connects to a network in a wireless and/or wired manner. In some embodiments, the processing device 702 may include or operate in conjunction with a graphics processing unit (GPU).

In embodiments, the processing device 702 executes an image processing system 720. The image processing system 720 receives images and performs one or more processing operations. In embodiments, the image processing system 720 includes an editing system 722, a classification system 724, and a genome generation system 726. In embodiments, the image processing system 720 may receive the images from the image capture device 704 and/or may download, or otherwise electronically receive, images from another device via a network.

In embodiments, the editing system 722 is configured to edit images. Editing images may include changing one or more characteristics of the image (e.g., brightness, color, tilt, pan, zoom, etc.). In embodiments, the editing system 722 is configured to merge two or more images. For example, a user may have one image that depicts a certain background (e.g., mountains, beach, gym, etc.) and a second image that depicts a model. In this example, the editing system 722 may merge the two images, such that the model is depicted in the foreground and the background is depicted in the background. In some embodiments, the editing system 722 performs blob detection, edge detection, and/or feature extraction to identify objects in the images. For example, in the second image containing the model, the editing system 722 may identify the model in the image using blob detection, edge detection, and/or feature extraction. In some embodiments, the editing system 722 may configured to alter one or more features of the image. For example, the editing system 722 may alter backgrounds, clothing, background props, or the like. The editing system 722 may perform other editing operations on images without departing from the scope of the disclosure.

In embodiments, the image classification system 704 receives images and performs image classification on the images. In embodiments, the image classification system 704 processes and classifies a set of images. In embodiments, the image classification system 704 may classify the image itself and/or classify one or more aspects of the image. The image classification system 704 may leverage one or more classification models (e.g., stored in the model datastore 740) to determine a set of attributes of the image. In some embodiments, the image classification system 704 receives the images from the editing system 722, extracts one or more features of each image, and generates one or more feature vectors for each image based on the extracted features. The image classification system 722 may feed the respective feature vectors into one or more classification models (e.g., image classification models). The classification models, for each feature vector, may output a respective classification based on the feature vector. In some embodiments, each classification may include a confidence score that indicates a degree of confidence in the classification given the classification model and the features of the image.

In embodiments, the genome generation system 726 may, for each image, canonicalize a data set obtained from the classification of the images to obtain an image genome of the image. The genome generation system 726 may populate a data structure with the media asset attributes of the image derived from the classification process to obtain an image genome of the image. The genome generation system 726 may canonicalize the data set into an image genome data structure in accordance with a predefined ontology or schema that defines the types of attributes that may be attributed to an image and/or specific classes of images (e.g., landscapes, action photos, model poses, product photos, etc.). In embodiments, the ontology/schema of an image genome may include the entire set of media asset attributes that may be attributed to an image, whereby the data structure corresponding to the image may be parameterized with the attributes of any given media asset.

In embodiments, the genome generation system 726 may, for each image, extract a set of additional features from the image. The genome generation system 726 may perform various types of feature extraction, including calculating ratios of different elements of a subject, sizes of a subject in relation to other objects in the image, and the like. The genome generation system 726 may augment the image genome with the additional extracted features.

In embodiments, the genome generation system 726 associates, for each image, the image genome with the image. In embodiments, the genome generation system 726 may store a UUID, or any other suitable unique identifier of the image, in the image genome or in a database record corresponding to the image genome.

In embodiments, self-contained photography system 190 propagates the set of images into one or more digital environments. In embodiments, the image processing system 720 may embed tags and/or code (e.g., JavaScript code) into the images that allows tracking data to be recorded and reported, as well as available user data when the image is presented to a user. In embodiments, the self-contained photography system 190 may propagate an image by placing the image in digital advertisements, social media posts, websites, blogs, and/or other suitable digital environments. The images may be propagated by other applications that are executed by the self-contained photography system 190. In some embodiments, the image processing system 720 provides the set of images to a client associated with an entity (e.g., a customer), such that the entity can propagate the set of images to the digital environments. In this way, any data collected with respect to the entity may be used by the entity (e.g., on the digital anthropology and creative intelligence system 100 described above).

The image processing system 726 may perform additional or alternative functions. For example, in embodiments, the image processing system 726 implementations and examples of media processing and tracking as provided in PCT Application Number US2019/049074, entitled “TECHNOLOGIES FOR ENABLING ANALYTICS OF COMPUTING EVENTS BASED ON AUGMENTED CANONICALIZATION OF CLASSIFIED IMAGES”, the contents of which are incorporated by reference.

In embodiments, the storage device stores an image datastore 730 and a model datastore 740. In embodiments, the image datastore 730 stores images captured by the image capture device 704 and/or processed by the image processing system 720. In embodiments, the image datastore 730 may store the image genomes of processed images. In embodiments, the image datastore may store metadata relating to the image, such as a time the image was captured, a location where the image was captured, the user who captured the image, the entity that owns the image, when the image was propagated, the manner by which the image was propagated, and the like.

In embodiments, the model datastore 740 stores one or more machine-learned models that are used by the self-contained photography system 190. In embodiments, the model datastore 740 may store image classification models that are used by the self-contained photography system 190 (e.g., topic models, customer segmentation models, language processing models, and/or the like). The model datastore 740 may store additional or alternative machine-learned models without departing from the scope of the disclosure. In some embodiments, the model datastore 740 may store machine-learned models that are trained on the self-contained photography system 190.

In embodiments, the self-contained photography system 190 may act as a host 500 that is used by the digital anthropology services system 108. In these embodiments, the self-contained photography system 190 may receive a client algorithm 502 and execute the client algorithm to train a local model. In these embodiments, the client algorithm 502 may generate results that indicate the model parameters of the local model and may return the results to the digital anthropology services system 108 (e.g., to the master algorithm 514).

While only a few embodiments of the present disclosure have been shown and described, it will be obvious to those skilled in the art that many changes and modifications may be made thereunto without departing from the spirit and scope of the present disclosure as described in the following claims. All patent applications and patents, both foreign and domestic, and all other publications referenced herein are incorporated herein in their entireties to the full extent permitted by law.

The methods and systems described herein may be deployed in part or in whole through a machine that executes computer software, program codes, and/or instructions on a processor. The present disclosure may be implemented as a method on the machine, as a system or apparatus as part of or in relation to the machine, or as a computer program product embodied in a computer readable medium executing on one or more of the machines. In embodiments, the processor may be part of a server, cloud server, client, network infrastructure, mobile computing platform, stationary computing platform, or other computing platforms. A processor may be any kind of computational or processing device capable of executing program instructions, codes, binary instructions and the like, including a central processing unit (CPU), a general processing unit (GPU), a logic board, a chip (e.g., a graphics chip, a video processing chip, a data compression chip, or the like), a chipset, a controller, a system-on-chip (e.g., an RF system on chip, an AI system on chip, a video processing system on chip, or others), an integrated circuit, an application specific integrated circuit (ASIC), a field programmable gate array (FPGA), an approximate computing processor, a quantum computing processor, a parallel computing processor, a neural network processor, or other type of processor. The processor may be or may include a signal processor, digital processor, data processor, embedded processor, microprocessor or any variant such as a co-processor (math co-processor, graphic co-processor, communication co-processor, video co-processor, AI co-processor, and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more threads. The thread may spawn other threads that may have assigned priorities associated with them; the processor may execute these threads based on priority or any other order based on instructions provided in the program code. The processor, or any machine utilizing one, may include non-transitory memory that stores methods, codes, instructions and programs as described herein and elsewhere. The processor may access a non-transitory storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache, network-attached storage, server-based storage, and the like.

A processor may include one or more cores that may enhance speed and performance of a multiprocessor. In embodiments, the process may be a dual core processor, quad core processors, other chip-level multiprocessor and the like that combine two or more independent cores (sometimes called a die).

The methods and systems described herein may be deployed in part or in whole through a machine that executes computer software on a server, client, firewall, gateway, hub, router, switch, infrastructure-as-a-service, platform-as-a-service, or other such computer and/or networking hardware or system. The software may be associated with a server that may include a file server, print server, domain server, internet server, intranet server, cloud server, infrastructure-as-a-service server, platform-as-a-service server, web server, and other variants such as secondary server, host server, distributed server, failover server, backup server, server farm, and the like. The server may include one or more of memories, processors, computer readable media, storage media, ports (physical and virtual), communication devices, and interfaces capable of accessing other servers, clients, machines, and devices through a wired or a wireless medium, and the like. The methods, programs, or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers, social networks, and the like. Additionally, this coupling and/or connection may facilitate remote execution of programs across the network. The networking of some or all of these devices may facilitate parallel processing of a program or method at one or more locations without deviating from the scope of the disclosure. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs, or codes as described herein and elsewhere may be executed by the client. In addition, other devices required for the execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of programs across the network. The networking of some or all of these devices may facilitate parallel processing of a program or method at one or more locations without deviating from the scope of the disclosure. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements. The methods and systems described herein may be adapted for use with any kind of private, community, or hybrid cloud computing network or cloud computing environment, including those which involve features of software as a service (SaaS), platform as a service (PaaS), and/or infrastructure as a service (IaaS).

The methods, program codes, and instructions described herein and elsewhere may be implemented on a cellular network with multiple cells. The cellular network may either be frequency division multiple access (FDMA) network or code division multiple access (CDMA) network. The cellular network may include mobile devices, cell sites, base stations, repeaters, antennas, towers, and the like. The cell network may be a GSM, GPRS, 3G, 4G, 5G, LTE, EVDO, mesh, or other network types.

The methods, program codes, and instructions described herein and elsewhere may be implemented on or through mobile devices. The mobile devices may include navigation devices, cell phones, mobile phones, mobile personal digital assistants, laptops, palmtops, netbooks, pagers, electronic book readers, music players and the like. These devices may include, apart from other components, a storage medium such as flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer-to-peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g., USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, network-attached storage, network storage, NVME-accessible storage, PCIE connected storage, distributed storage, and the like.

The methods and systems described herein may transform physical and/or intangible items from one state to another. The methods and systems described herein may also transform data representing physical and/or intangible items from one state to another.

The elements described and depicted herein, including in flow charts and block diagrams throughout the figures, imply logical boundaries between the elements. However, according to software or hardware engineering practices, the depicted elements and the functions thereof may be implemented on machines through computer executable code using a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices, artificial intelligence, computing devices, networking equipment, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps associated therewith, may be realized in hardware, software or any combination of hardware and software suitable for a particular application. The hardware may include a general-purpose computer and/or dedicated computing device or specific computing device or particular aspect or component of a specific computing device. The processes may be realized in one or more microprocessors, microcontrollers, embedded microcontrollers, programmable digital signal processors or other programmable devices, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine-readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions. Computer software may employ virtualization, virtual machines, containers, dock facilities, portainers, and other capabilities.

Thus, in one aspect, methods described above and combinations thereof may be embodied in computer executable code that, when executing on one or more computing devices, performs the steps thereof. In another aspect, the methods may be embodied in systems that perform the steps thereof and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

While the disclosure has been disclosed in connection with the preferred embodiments shown and described in detail, various modifications and improvements thereon will become readily apparent to those skilled in the art. Accordingly, the spirit and scope of the present disclosure is not to be limited by the foregoing examples, but is to be understood in the broadest sense allowable by law.

The use of the terms “a” and “an” and “the” and similar referents in the context of describing the disclosure (especially in the context of the following claims) is to be construed to cover both the singular and the plural, unless otherwise indicated herein or clearly contradicted by context. The terms “comprising,” “with,” “including,” and “containing” are to be construed as open-ended terms (i.e., meaning “including, but not limited to,”) unless otherwise noted. Recitations of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. The term “set” may include a set with a single member. No language in the specification should be construed as indicating any non-claimed element as essential to the practice of the disclosure.

While the foregoing written description enables one skilled to make and use what is considered presently to be the best mode thereof, those skilled in the art will understand and appreciate the existence of variations, combinations, and equivalents of the specific embodiment, method, and examples herein. The disclosure should therefore not be limited by the above described embodiment, method, and examples, but by all embodiments and methods within the scope and spirit of the disclosure.

All documents referenced herein are hereby incorporated by reference as if fully set forth herein.

What is claimed is:

1. A method comprising:
receiving, by a processing system, a media asset;
classifying, by the processing system, one or more elements of the media asset using a media asset classifier to obtain a set of classifications;
attributing, by the processing system, the set of classifications to the media asset as media asset attributes;
generating, by the processing system, a media asset genome for the media asset based on the media asset attributes;
associating, by the processing system, the media asset genome with the media asset;
embedding, by the processing system, at least one of a tag and code into the media asset that causes a client application presenting the media asset to report tracking information relating to presentation of the media asset;
propagating, by the processing system, the media asset into at least one digital environment;
receiving, by the processing system, tracking information from one or more external devices that presented the media asset to respective on-line users, each instance of tracking information indicating a respective outcome of a respective on-line user with respect to the media asset;
receiving, by the processing system, user data of the respective on-line users that were presented the media asset; and
training, by the processing system, a digital anthropology system that performs marketing-related tasks based, at least in part, on the media asset genome, the tracking data relating to the media asset genome, and the user data of the respective on-line users.

2. The method of claim 1, wherein the training of the digital anthropology system is further based on integrated data that is integrated from two or more other independent data sources.

3. The method of claim 2, further comprising multi-basing the media asset genome, the tracking data, and the user data with the two or more other independent data sources.

4. The method of claim 2, wherein the integrated data is generated by multi-basing data from the two or more independent data sources.

5. The method of claim 4, wherein the multi-basing is performed on-demand, such that the integrated data resulting from the multi-basing is not persistently stored.

6. The method of claim 2, wherein the integrated data is integrated using data fusion techniques.

7. The method of claim 2, wherein the integrated data is integrated using data ascription techniques.

8. The method of claim 1 further comprising:
extracting one or more features of the media asset, wherein the media genome is further based on the one or more extracted features of the media asset.

9. The method of claim 7, wherein extracting the one or more features includes calculating a ratio of two different elements of a subject in the image.

10. The method of claim 7, wherein extracting the one or more features includes calculating the sizes of a subject in the image in relation to other objects in the image.

11. An image capture device comprising:
one or more lenses;
a storage device;
one or more processors that execute executable instructions that cause the one or more processors to:
capture an image via the one or more lenses;
classify one or more elements of the media asset using an image classifier;
attribute the classifications of the one or more elements to the media asset as media asset attributes;
generate a media asset genome for the media asset based on the media asset attributes;
associate the media asset genome with the media asset; and
transmit the media asset genome and the media asset to an external device.

12. The system of claim 11, wherein the image capture device is a digital camera.

13. The system of claim 11, wherein the image capture device is a pair of smart glasses.

14. The system of claim 11, wherein the image capture device is a self-contained photography studio system.

15. The system of claim 11, wherein the external device is a creative intelligence server.

16. The system of claim 11, wherein the executable instructions further cause one or more processors to extract one or more features of the image.

17. The system of claim 16, wherein extracting the one or more features includes calculating a ratio of two different elements of a subject in the image.

18. The system of claim 16, wherein extracting the one or more features includes calculating the sizes of a subject in the image in relation to other objects in the image.

19. The system of claim 11, wherein the executable instructions further cause the one or more processors to embed one or more tags and/or code into the media asset that causes a client application presenting the media asset to report tracking information relating to presentation of the media asset.

20. The system of claim 11, wherein the tracking data includes telemetric data relating to the media asset.

21. The system of claim 11, wherein the tracking data includes metadata relating to the media asset.

22. A method comprising:
receiving, by one or more processors, a use case relating to a marketing-related task to be performed on behalf of a customer;
providing, by the one or more processors, a client algorithm to a set of hosts via a communication network, wherein the client algorithm includes a set of machine executable instructions that define a machine learning algorithm that trains a local model on a respective local data set stored by the host and provides respective results of the training to a master algorithm that is executed by the one or more processors, wherein at least one of the hosts stores a sensitive data set that is not under control of the customer;
receiving, by the one or more processors, the respective results from each of the set of hosts;
updating, by the one or more processors, a global model based on the results received from the set of hosts;
receiving, by the one or more processors, a request to perform a marketing-related task on behalf of the customer; and
leveraging, by the one or more processors, the global model to perform the marketing-related task.

23. The method of claim 22, wherein the respective results that are received from each of the set of hosts include a respective set of model parameters resulting from training the respective version of the local model.

24. The method of claim 23, wherein updating the global model includes integrating the respective set of model parameters received from each of the hosts into the global model.

25. The method of claim 24, further comprising providing, by the one or more processors, respective meta-learning information to each of the hosts in response to integrating the respective set of parameters.

26. The method of claim 1, wherein providing the candidate algorithm to the set of hosts includes providing a starter model to each of the hosts, wherein each respective host of the set of hosts trains the respective local model from the starter model.

27. The method of claim 5, wherein the starter model is initially trained on a representative data set.

28. The method of claim 27, wherein providing the candidate algorithm to the set of hosts includes providing the set of representative data to the set of hosts, wherein each respective host of the set of hosts validates the respective local model using the representative data set.

29. The method of claim 22, wherein the marketing-related task is customer segmentation.

30. The method of claim 22, wherein the marketing-related task is topic modeling.

31. The method of claim 22, wherein the marketing-related task is market planning.

32. The method of claim 22, wherein the set of hosts includes a computing environment of a commercial partner of the customer.

33. The method of claim 32, wherein the commercial environment of the customer stores sales data of the commercial partner.

34. The method of claim 32, wherein the commercial environment of the customer stores sales data of the commercial partner.

35. The method of claim 22, wherein the set of hosts include a computing environment that includes multi-based data from two independent data sources.

36. The method of claim 22, wherein the set of hosts include a computing environment that stores media asset analytics data.
